(19) United States
(12) Patent Application Publication
(10) Pub. No.: US 2007/0100591 A1
(43) Pub. Date: May 3, 2007

(54) Parameter extracting device and parameter extracting method in simulation, photomask created from parameter extracting method, and semiconductor device

(75) Inventor: Katsuhiko Harazaki, Nara-shi (JP)

Correspondence Address: NIXON & VANDERHYE, PC, 901 NORTH GLEBE ROAD, 11TH FLOOR, ARLINGTON, VA, 22203, US

(73) Assignee: SHARP KABUSHIKI KAISHA, Osaka (JP)

(21) Appl. No.: 11/582,548

(22) Filed: Oct. 18, 2006

(30) Foreign Application Priority Data
Oct. 18, 2005 (JP) 2005-303251
Oct. 5, 2006 (JP) 2006-274298

(51) Int. Cl. G06F 17/10

(52) U.S. Cl. 703/2

(57) ABSTRACT

The present invention provides a device for extracting optimum parameters in a simulation at high precision and in a short period of time. The present invention also provides a photomask created using the lithography parameters obtained from the device, and a semiconductor device. The device includes a parameter setting section for setting a plurality of parameters necessary in a simulation; a first parameter extracting section for extracting parameters adapted to the simulation through a genetic algorithm or a simulated annealing method from the plurality of set parameters; and a second parameter extracting section for registering the extracted parameters through a high precision parameter extracting method, and fitting the parameters at high precision.

### CROSS-REFERENCE TO RELATED APPLICATION

This application is related to Japanese Patent Application No. 2005-303251 filed on Oct. 18, 2005, and No. 2006-274298 filed on Oct. 5, 2006 whose priorities are claimed and the disclosure of which is incorporated by reference in its entirety.

### BACKGROUND OF THE INVENTION

1. Field of the Invention

The present invention relates to a parameter extracting device and a parameter extracting method for extracting parameters when performing a simulation. More specifically, the present invention relates to a device for extracting parameters and a parameter extracting method in the lithography simulation of an exposure mask used in light or X-ray or E-beam exposure method. The present invention further relates to a device for extracting parameters and a parameter extracting method in the semiconductor manufacturing process or device simulation.

In particular, the present invention relates to parameter extracting device and method for optimizing the correction (optical proximity effect correction or process proximity effect correction including etching, pattern correction that takes into consideration the electrical property and the variation of the transistor and so on) of the design data used in the mask pattern.

The present invention further relates to a method of creating exposure mask suited to a microscopic LSI pattern formation, and aims to automate the creation task of the exposure mask. The present invention further relates to an exposure mask formed by using the parameter extracting method and a semiconductor device manufactured using the exposure mask.

2. Description of Related Art

Recently, in development and manufacturing of the semiconductor integrated circuit or system liquid crystal display device, the design and experimental manufacture thereof are often performed through simulations or through a plurality of calculating equations, empirical equations etc. When performing a simulation, a great amount of parameters are used in the simulation and the preferred effects cannot be obtained unless the selection of the parameter and the parameter values are appropriate. However, the selection of the great number of parameters and the setting of the parameter values are determined by experience in workplaces of production and development where the deadline is drawing on, and the optimum values are obtained through trial and error.

Recently, the LSI is becoming higher integrated, and the size of the elements thereof is becoming more miniature and is becoming larger in scale. In the liquid crystal display, the area is becoming larger, and the pixels and the TFTs thereof are becoming of higher definition. In the lithography process directly related to the micro-fabrication of such elements, the size of the transfer pattern becomes smaller than the exposure wavelength, and thus linearity of the pattern transfer becomes a concern. This is referred to as the optical proximity effect, and specifically, the 90 degrees corners become rounded by the diffraction of light and the line ends become shorter since the exposure wavelength is greater than the size of the transfer pattern, and similarly, a phenomenon occurs in which the width of the wirings changes with denseness of the wiring from the interference action of the light.

The cause of the optical proximity effect is mainly due to optical reasons such as literally described above, but also includes the influence of the resist process (pre-exposure bake, PEB (Post Exposure Bake), development etc.) and base (shape, structure, material), influence of etching and the like.

In the photolithography process, such optical proximity effect becomes the cause of deviation from the specification. In order to prevent this, a method of applying correction to the mask anticipating such displacement amount in advance is generally used. This is referred to as the optical proximity effect correction (OPC). Recently, the process proximity effect correction (PPC) including the etching shift etc. after photo to the OPC is also being used. Such processes are hereinafter referred to as OPC or PPC.

In the micro-fabrication technique after the 90 nm or 65 nm process of advancing miniaturization, LER (Line Edge Roughness) becomes a concern. Dimensional deviation and variation caused by the LER influence the electrical property of the transistor. The electrical property of the transistor is determined not only by the dimensional deviation and the variation caused by miniaturization, but also by various other factors. The other factors include, for example, disturbance and deviation of the injection profile etc. caused by ion injection of impurity species. These problems are addressed in the semiconductor manufacturing process and device simulation. Similar to the lithography simulation, the method of performing the mask pattern correction taking the above problems into consideration is referred to as the EPC (Electrical Pattern Correction) with respect to the pattern correction based on the electrical property of the transistor. The description of the EPC is shown in FIG. 23. In this case, the variation of the threshold value (Vth) caused by the line width variation of the transistor is reduced by the EPC (pattern correction based on electrical property).

As shown in FIG. 23(a), the EPC process includes a design data collecting step 18-1, EPC processing step 18-2, EPC processed data creating step 18-3, mask drawing data conversion step 18-4, mask drawing data collecting step 18-5, and mask producing step 18-6.

In the EPC processing step 18-2, the variation of the line width caused by the photolithography simulation is checked in step 2a, as shown in FIG. 23(b). For example, the diffusion region is divided into strip forms within the same pattern as in MOS1, MOS2, MOS3, . . . within the same pattern of the diffusion region, as shown in FIG. 23(c), and the gate length for each region is extracted to review the distribution of the line width variation. Next, in step 2b, the variation of the electrical property caused by the process and device simulation is checked. That is, the process and device simulation is performed in the range of the distribution extracted in step 2a, and the variation distribution of the electrical property is reviewed. In step 2c, the electrical property target is set. That is, the electrical property to be corrected, for example, the threshold voltage (Vth) of the transistor is set. In step 2d, the correcting region and the correcting amount are determined. In this case, the correcting amount is determined for each region to be corrected. That is, as shown in the relationship between the electrical property target and the correcting object in FIG. 23(d), the predetermined ranges on both sides with the threshold value Vth of a predetermined range as the center is the correcting object, and the correcting amount is determined for each region. Next, in step 2e, the corrected mask pattern data is created.

Therefore, according to the EPC processing step of FIG. 23, the design data for producing the desired mask is collected and the photolithography simulation is performed using the relevant data to check the variation of the line width and the distribution of the electrical property of each element. Next, the electrical property target is set, and the correcting range and the correcting amount are determined to create the corrected mask pattern data. The mask is produced from the mask pattern data.

Two main types of methods are known for the OPC or PPC (or EPC). One is a method of performing the correction based on the correction rule obtained in advance, or the so-called rule base OPC. The other is a method referred to as the simulation base OPC in which the exposure process is modeled. The simulation base OPC (or model base OPC) is the mainstream in the current leading LSI manufacturing process in which miniaturization is advancing.

An example of the OPC pattern of the memory cell is shown in FIG. 24. FIG. 24 shows a gate polysilicon layer of the OPC pattern of one portion of the SRAM memory cell, where FIG. 24(a) shows the OPC pattern of the SRAM of before verification, and FIG. 24(b) shows the OPC pattern of after verification and repairing. The location surrounded with a dotted line in the OPC pattern before verification shown in FIG. 24(a) is the location to pay particular attention to, where the pattern interval between the lines that was 0.110 [symbol] m (nearly short on Wafer) before the verification improved to 0.118 [symbol] m (0.166 [symbol] m on Wafer) after the OPC verification, thereby ensuring the specification and reducing the risk of short circuit. The square dotted line portions of FIG. 24 show the transistor forming portion.

FIG. 25 shows the contact layer OPC pattern of the flash memory cell. FIG. 25(a) shows the pattern before OPC, FIG. 25(b) shows a partially enlarged view. The locations indicated by LSI1 to LSI4 in the figure are memory cell portions. The enlargement of the location circled with the dotted line of FIG. 25(b) is shown in FIG. 25(c). FIG. 25(c) shows the SEM shape after photo of the C layer, where the hole diameter is 125 m and the pitch is 230 m.

In the model base OPC that assumes an experimental model in addition to the simulation, the greatest problem is the fitting of the lithography parameter. The number of lithography parameters is in total 20 to 30 or more types including 5 to 7 or more types of exposure device parameters, 10 or more types of resist process related parameters, and furthermore, 10 or more types of mask related or for calculation process. Among them, the suitable values of the parameters related to the exposure device, or related to the mask or the one part related to the resistor are known to a certain extent, but are mostly unknown, and thus the selection of the parameters and suitable setting of such values are essential in creating the OPC model (experimental model). The number of parameters further increases in PPC that includes the effects of etching, and becomes greater than or equal to ten times the PPC for the EPC.

Conventionally, the processes illustrated in the processing flow of FIG. 26 are performed to obtain the optimum solution of the lithography parameter. First, the extraction data related to photolithography, OPC are measured (S51). Then, the measured data are numerically input by the hand of the technician (S52), and the calculation process is performed by EWS (Engineering Work Station), PC(Personal computer) (S53). The parameters and the actual measurement result are compared and then checked and corrected to select the parameters and to extract the parameter values step by step. In the series of processes, the necessary parameters are selected and the optimum value of each parameter is extracted step by step by repeating the calculation process (S53) by EWS, PC, and the registration process (S54) in which the parameter is compared with the actual measurement result and then checked and corrected by the technician. Normally, a few weeks to a month are required to repeat the above processes and to extract the parameter step by step.

The details of the registration process shown in steps S51 to S54 of FIG. 26 is shown in FIG. 27. FIG. 27 shows the registration process of the lithography parameter in a projection optical system of an exposure device as a specific example. In a first step S61, parameters which optimum value is known to a certain extent such as ë and numerical aperture (NA), defocu s value or the variable range of the projection lens, that is, the quasi fixed values are set. The lithography parameter list is shown in FIG. 28, where the quasi fixed values are shown in No. 1 to No 5 of FIG. 28. FIG. 28 also shows, as one example, that a plurality of parameters exists, and shows the parameter name, the description of the content thereof, and the actual measured value.

In the second step S62, the denseness of the line width caused by pitch dependency is set. That is, the registration of the basic pitch dependence is performed as the primary setting. The parameters in this case are órs, óesi, wti, Ropc etc.

In the third step S63, the registration of linearity is set for the line width. The parameters are órs, óesi, wti, Ropc for the secondary setting in this case.

In the fourth step S64, the registration of the line end is set for the interval of the line ends. The line width alignment and fine tuning are set. In addition to órs, óesi, wti, and Ropc, number of modeling function, order M and dimensional number in ö the sampling space are the parameters for the tertiary setting.

The resist parameters in time of OPC model creation used in the primary to the tertiary setting are shown in No. 6 to No. 8 of FIG. 28. The parameters in the OPC process used in the primary to the tertiary setting are shown in No. 9 to No. 11 of FIG. 28.

After the above setting, the parameters are extracted, determination is made on whether or not the parameters are within the specification defined in advance in step S65, where the parameters registered at this point are output for creation of model if the parameters are within the specification. However, if the parameters are not within the specification, the process returns to one of the steps of second step S62 to fourth step S64, and the parameters are again changed and the registration is performed. Alternatively, the process returns to the first step S61, and the quasi fixed values are changed and the correction of registration is performed. When the parameters are within the specification after repeating such tasks, the N^{th} setting is performed for other parameters. If the optimum parameters are obtained as a result, the model is created based on such parameters.

The registration of the projection optical system lithography parameter has been explained, but similar registration is also performed on the parameters in resist exposure, reaction of chemical amplification resist, bake, resist exposure. FIG. 29 shows the OPC calculation model and the registration parameter, where the registration function for performing registration with the experiment data is as shown in equation (1) described in FIG. 29.

FIG. 29(a) shows the optical intensity distribution, FIG. 29(b) shows the resist property distribution of the chemical amplification resist, and FIG. 29(c) shows the etching property distribution. In addition, the calculation of an effective value is performed through experiment with respect to the values (quasi fixed values) of the manufacturing device such as NA/σ and the like of the exposure device for higher precision of the OPC model.

The registration task of the lithography parameter has been described, but such task is basically similarly performed in the parameter registration task of ion injection or other processing steps, or the device simulation.

The parameters shown in FIG. 28 are representative parameters and many other parameters exist. Thus, a vast amount of calculation is performed if the great amount of parameters are simply allocated and combined without the thinking of the humans.

Therefore, a method of using the lithograph simulation called model base or calculating equation is used in the optical proximity effect correction, but in many cases, includes a plurality of optimum parameters. Thus, a great amount of effort, that is, hand is required in the calculation of the optimum value of such great amount of parameters, and the load by such effort puts stress on the processing cost in the current leading LSI manufacturing process in which miniaturization is advancing.

With regards to the parameter extraction task, the reduction in the load of the work, addressing of automation and the like are recently beginning to be performed, and a method using a genetic algorithm (GA) is being reviewed.

A great number of applications have been filed for patent for the pattern correction method in OPC or PPC, and a specific example is shown in patent articles 1 to 4.

Patent article 1 (Japanese Laid-Open Patent Publication No. 2004-302263) is a method for performing the OPC process at high precision and at high speed by devising the boundary process of the two regions in the hybrid OPC process combining the model base OPC and the rule base.

Patent article 2 (Japanese Laid-Open Patent Publication No. 2005-134520) is a patent regarding the method of creating the OPC mask pattern data of high precision without defect while maintaining the process margin.

Patent article 3 (Japanese Laid-Open Patent Publication No. 2000-511697) is a patent related to genetic algorithm. Patent article 3 is an application example related to an optical parameter analysis device of a thin film of the genetic algorithm (GA).

Patent article 4 (Japanese Laid-Open Patent Publication No. 6-161980) applies the method of genetic algorithm in increasing the speed of the calculator architecture.

### SUMMARY OF THE INVENTION

With advancement in miniaturization of elements and stricter specification in fabrication of each step, the accuracy of the parameters defining the specifications is demanded thereby further extending the extraction period, and thus the extraction period must be shortened.

Recently, for the device and method for extracting the optimum parameters in the simulation at high precision and in a short period of time, a method using the genetic algorithm (GA) is being reviewed, but if the conventionally known method is simply used, the parameter extraction itself may not converge, the solution may be wrong, and even if the solution is obtained, a great amount of time is required.

The present invention, in view of the above problems, aims to provide a device and a method of extracting the optimum parameters in the simulation at high precision and in a short period of time. The present invention also aim to provide a device and a method of extracting the parameters of semiconductor manufacturing process/device simulation or parameters of lithography at high precision and in a short period of time, and a photomask formed using the parameters of the process/device simulation or the lithography parameters and a semiconductor device.

The parameter extracting device in a simulation according to the present invention includes, a parameter setting section for setting a plurality of parameters necessary in a simulation; a first parameter extracting section for extracting parameters adapted to the simulation through a genetic algorithm or a simulated annealing method from the plurality of set parameters; and a second parameter extracting section for registering the extracted parameters through a high precision parameter extracting method, and fitting the parameters at high precision, wherein the optimum parameters are extracted at high precision in a short period of time.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a block diagram of a parameter extracting device according to the present invention;

FIG. 2 is an explanatory view of the calculating procedures of a distributed GA according to the method of the present invention;

FIG.3 is an explanatory view of the calculating procedures of the distributed GA or SA method according to the method of the present invention;

FIG. 4 is an explanatory view showing the calculating procedures of the GA;

FIG. 5 shows the conceptual diagram of the operation of the GA;

FIG. 6 shows a basic configuration view of SA;

FIG. 7 is a basic processing flow chart of SA;

FIG. 8 is a control flow chart of SA;

FIG. 9 is a view showing the TEG pattern for creating OPC model of the contact layer;

FIG. 10 is a view showing a specific example of the measurement data and parameter set;

FIG. 11 is an entire view of the parameter extracting flow;

FIG. 12 is a detailed view of the parameter extracting flow;

FIG. 13 is a view showing the genetic operation iterated for L times;

FIG. 14 is a flow chart of SA; and

FIG. 15 shows a flow chart of exchanging evaluation and exchange.

FIG. 16 is a view showing the parameter extracting flow according to the present example;

FIG. 17 is a view showing an OPC parameter set example (actual numerical value representation);

FIG. 18 is a view showing an OPC parameter fitting example;

FIG. 19 is a view showing the precision and the OPC processing time in each minimum solution;

FIG. 20 is a view showing the relationship between the minimum solution and the optimum solution;

FIG. 21 is a view explaining the time of the parameter extraction;

FIG. 22 is a view showing the time comparison of the parameter extraction;

FIG. 23 is an explanatory view of EPC (pattern correction based on electrical property);

FIG. 24 is a view showing an OPC pattern of an SRAM memory cell;

FIG. 25 is a view showing a pattern of a flash memory cell C layer;

FIG. 26 is a lithography parameter extracting flow according to the conventional method;

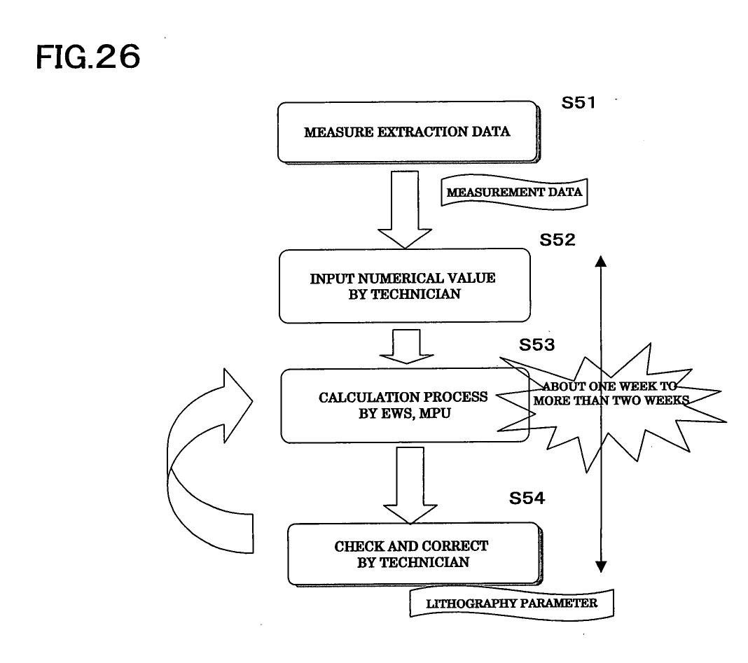

FIG. 27 is a detailed view of the extracting flow of the lithography parameter;

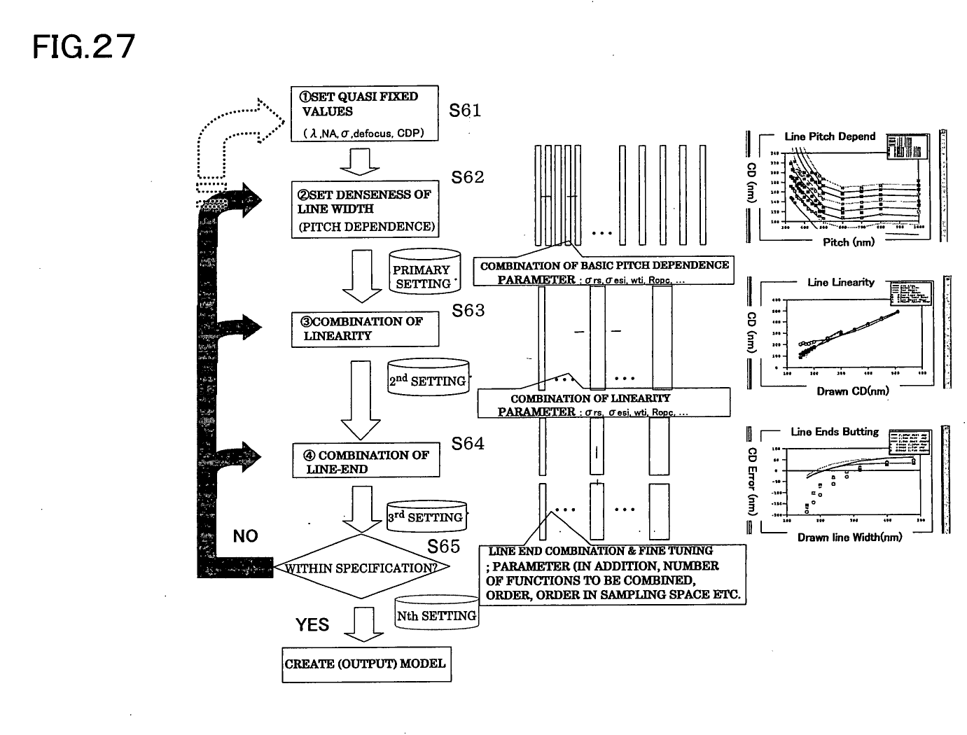

FIG. 28 is a view showing a table of lithography parameters; and

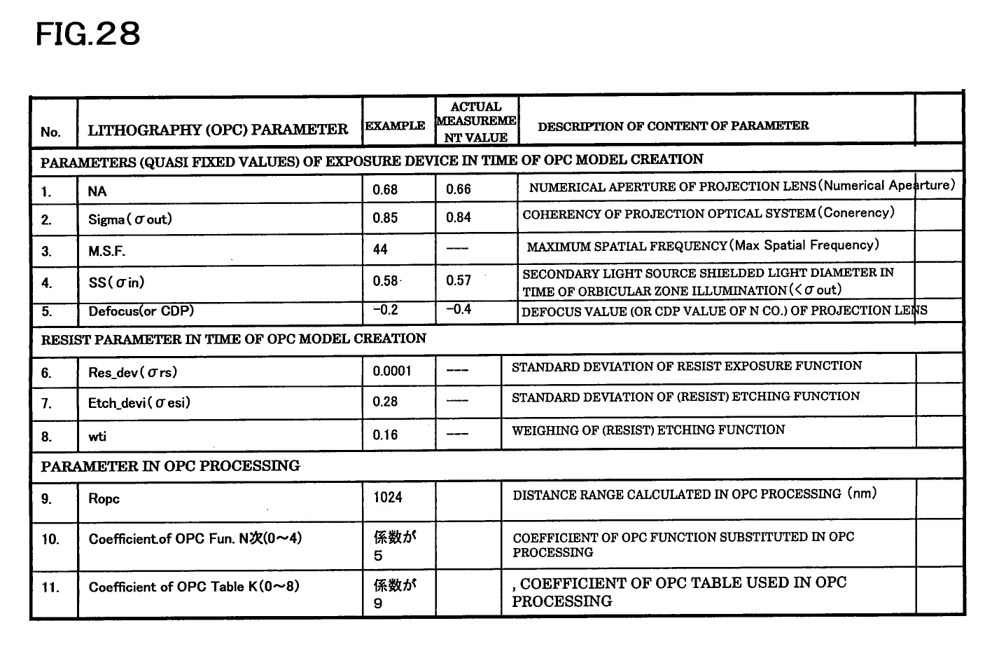

FIG. 29 is a view showing the OPC calculation model and the combined parameters.

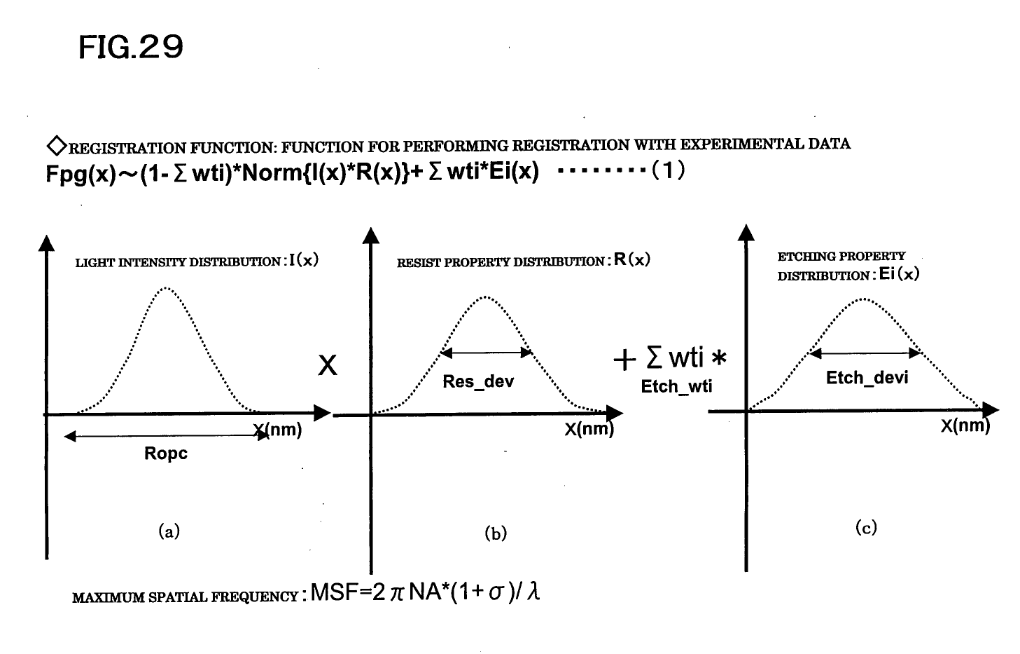

### DESCRIPTION OF THE PREFERRED EMBODIMENTS

The present invention devises the method of genetic algorithms (hereinafter referred to as GA) in order to extract the parameters in the simulation at high precision and in a short period of time. That is, a plurality of populations of parameter sets are set, and the parameter sets are moved between populations at a certain interval. The convergence is thereby improved, the searching time is shortened, and automation of the registration process is realized.

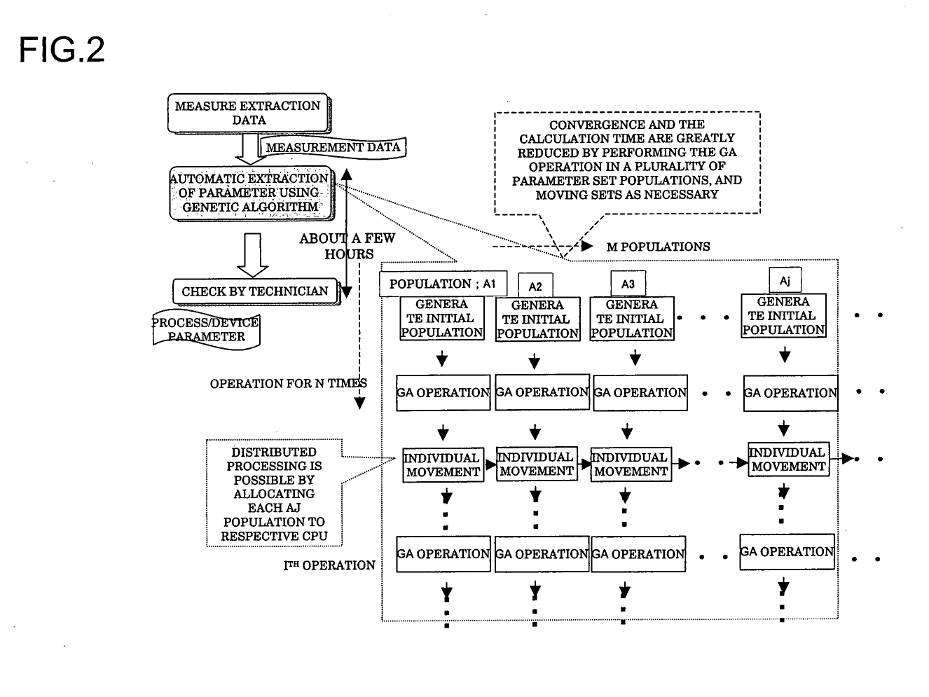

More specifically, a plurality of parameter set assemblies used in searching for the solution are set and the operation of GA is independently performed thereon. After repeating such operation, the specific parameter set is moved between the assemblies. This task is repeated over a plurality of times to perform the M generation operations for L times and obtain the solution. The GA method will be hereinafter described in FIGS. 2, 4, and 11˜13.

In such time calculator, it is efficient to allocate the parameter set assembly to each CPU and to perform distributed processing. Furthermore, different evaluation formulas can be used in the fitness evaluation of each assembly (setting of a plurality of conditions is facilitated).

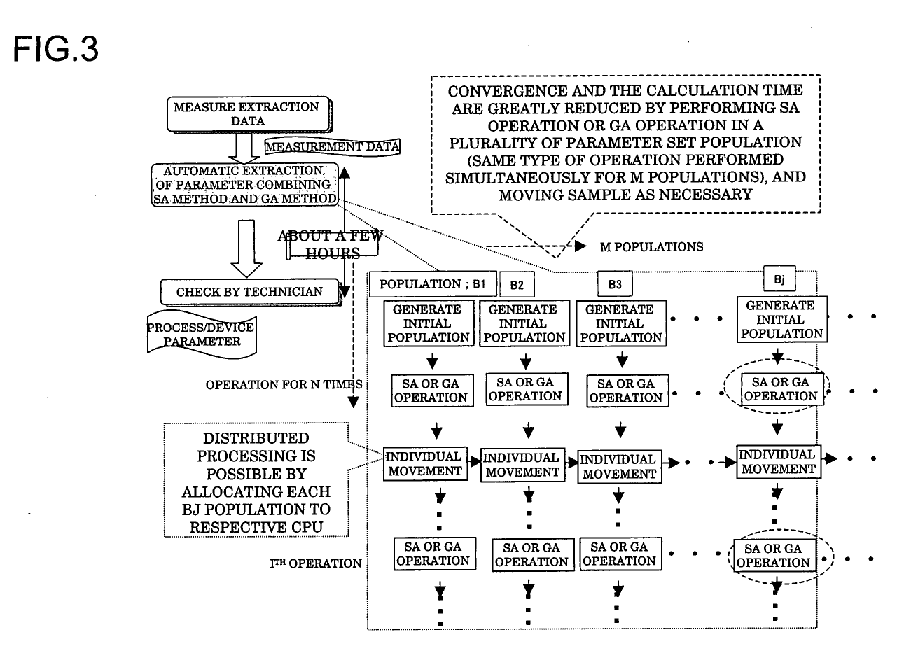

Similar effects can be anticipated not only with the GA method but also using the simulated annealing method (hereinafter referred to as SA). The two methods may be combined for use. In this case, improvement in convergence is further expected. SA method will be hereinafter described in FIGS. 3.8.14 and 15.

A high precision registration of the parameters can be realized by using the high precision parameter extracting method in addition to automation of the registration task by the GA method or the SA method. The high precision parameter extracting method includes a linear solving method and a non-linear solving method, where the least square method, the quasi Newton's method or the like is used in the present invention. The parameters are thereby fitted. In particular, with regards to the parameters calculated according to the GA, the precision is calculated from the difference in the actual measured value and the calculated value and the simulation processing time is calculated to have the precision and the time as the evaluation function.

For example, in the case of the lithography simulation, the present invention is a method of obtaining the calculating equation for obtaining the mask pattern or the optimum parameters in the lithography simulation when performing the correction of the mask pattern so that the resist pattern on the wafer becomes a desired dimension in the pattern forming step of the semiconductor integrated circuit. To this end, the following procedures are performed. First, the lithography parameters to be evaluated are specified, and a plurality of groups of the lithography parameters is generated according to the GA method or the SA method. The group of the theoretical data corresponding to the plurality of groups of the lithography parameters is then derived. The resist pattern dimension on the photo printed wafer is also measured. The theoretical data and the measurement data are compared, and the group of the theoretical group that best fits the measurement data is extracted to obtain the solution of the lithography parameter.

In the pattern forming step of the semiconductor integrated circuit, the optical proximity effect correction of the mask pattern such as OPC or PPC is essential when fabricating the resist pattern that is relatively smaller than the exposure wavelength. The present invention provides the extracting device and method of the lithography parameters in which high precision registration (with respect to actual measured value) is possible in a short period of time by automatically calculating the parameters to be used in the lithography simulator or the calculating equation according to the GA method or the SA method, and further combining the high precision parameter extracting method, for example, the least square method, quasi Newton's method or the like; the photomask formed with the pattern using the method of the present invention; and the semiconductor device.

This is similarly practicable in extracting parameters in the process/device simulation.

The present invention includes the following based on the above concepts.

A parameter extracting device in a simulation according to the present invention includes, a parameter setting section for setting a plurality of parameters necessary in a simulation; a first parameter extracting section for extracting parameters adapted to the simulation through a genetic algorithm or a simulated annealing method from the plurality of set parameters; and a second parameter extracting section for registering the extracted parameters through a high precision parameter extracting method, and fitting the parameters at high precision.

In the present invention, the parameter setting section desirably includes a population generating part for generating a plurality of parameter set populations from the plurality of parameters, a selecting part for selecting the parameter set population to be moved between the parameter set populations, and a movement part for moving the selected parameter set population between the parameter set populations. In this case, the plurality of parameter set populations are distributed processed with a plurality of CPUs or a plurality of MPUs.

In the present invention, the parameter setting section desirably includes an input part for inputting actual measurement data and system control data to be simulated, a data reading part for smoothing and normalizing the input actual measurement data, and a parameter range determining part for determining the range of the precision and the parameter value of the object to be simulated based on the read data.

The genetic algorithm of the present invention selects a parent from a parent selection table created by the set parameters, generates the individual of the next generation through the operations of crossing or recombination, or mutation of the parent, checks the constraint conditions of selecting the parameters adapted to the simulation with respect to the generated individual, performs the genetic operations for L times of deleting the individual not adapted to the constraint conditions and generating new parameters, and further repeats the genetic operations of L times for m generations to calculate a compatible value of the parameters.

Furthermore, the simulated annealing method of the present invention randomly selects an individual from the selection table created by the set parameters and calculates the cost or the energy function, performs the parameter exchanging operation so as to minimize the cost or the energy function to generate the next generation individual, checks whether the number of simulations, temperature, and thermal equilibrium state are satisfactory with respect to the generated individual, and calculates a compatible value satisfying the above conditions. The calculation includes calculating the difference between the actual measured value and the simulation value, and the calculating time of the evaluation parameter.

Furthermore, in the present invention, the first parameter extracting section desirably evaluates the extracted parameters through a precision calculated from the difference in the actual measured value and the calculated value or the processing time calculated using the characteristic pattern of the simulating object, or an evaluation function including the precision and the processing time, and extracts the parameters adapted to the simulation. The precision uses the function of weighing the sum of the squares of the difference of the measured value and the value of the selected group.

The second parameter extracting section of the present invention obtains an optimum solution of the parameters in which the error with the actual measured value is minimized. The second parameter extracting section includes a least square method or a quasi Newton's method.

According to another aspect, the present invention is a parameter extracting method in simulation including the steps of a parameter setting step for setting a plurality of parameters necessary in a simulation; a first parameter extracting step for extracting parameters adapted to the simulation through a genetic algorithm or a simulated annealing method from the plurality of set parameters; and a second parameter extracting step for registering the extracted parameters through a high precision parameter extracting method, and fitting the parameters at high precision is provided.

The operation based on the genetic algorithm desirably proportionate at least one gene type to the fitness thereof.

In the parameter extracting method in the simulation of the present invention, the optimum value of the extracted parameter is selected based on the function having the calculating time of performing the processes of optical proximity effect correction (OPC) or process proximity effect correction (PPC) or an electrical pattern correction (EPC) of the mask pattern as a minimum. Alternatively, the optimum value of the parameter extracted in the first parameter extracting step is selected based on the calculating time with an minimum isolated line or space pattern or densest line and space pattern based on the design rule or the unit pattern characteristic to the LSI. Furthermore, the optimum value of the parameter extracted in the first parameter extracting step is selected based on a value satisfying the performance required for the predicted value of the electrical property of the transistor by the process or device simulation, or a value in which the threshold value variation caused by line width variation becomes a minimum. Moreover, the optimum value obtained in the second parameter extracting step is compared with the measurement data in which the resist shape on a photo printed wafer is measured and data in which the electrical property of the pattern shape on the TEG evaluated wafer or the experimentally manufactured transistor is measured, and the parameter adapted to the measurement data is selected.

In the present invention, the parameter values of the optical proximity effect correction (OPC), process proximity effect correction (PPC), or electrical pattern correction (EPC) are extracted from the parameters obtained by the second parameter extracting step.

The present invention is a photomask using the corrected mask data created from the parameters extracted through the parameter extracting methods

The present invention is a semiconductor device manufactured using the photomask.

An optimum parameter extracting system comprising; an input unit for inputting actual measurement data and system control data; a control unit including a data reading section for smoothing and normalizing the input data, a parameter searching range determining section for determining a searching range of each parameter to be extracted, a plurality of first parameter extracting sections using a genetic algorithm, a selection unit for selecting a sample (i.e., specific parameter set) to be moved from a population of each parameter set, a movement unit for moving the sample between the populations of each parameter set, a second parameter extracting section using a high precision parameter extracting method, and a result outputting section for outputting a final solution extracted by the first parameter extracting sections and the second parameter extracting section; and a parameter database.

According to another further aspect, the present invention is a parameter extracting program executed by a computer, the program including the steps of a parameter setting step for setting a plurality of parameters necessary in a simulation; a first parameter extracting step for extracting parameters adapted to the simulation through a genetic algorithm or a simulated annealing method from the plurality of set parameters; and a second parameter extracting step for registering the extracted parameters through a high precision parameter extracting method, and fitting the parameters at high precision.

The present invention is a computer readable recording medium recorded with the program.

The parameter extracting device in the simulation of the present invention sets the assembly of a plurality of independent parameter sets suited for the distributed processing (a plurality of CPUs) based on the obtained precision and the searching range of solution, operates the parameter sets for each assembly of the set parameter sets based on the GA or the SA method, moves the parameter sets of each group at a certain interval, and repeats the operations. The sample set of satisfactory convergence and high precision is extracted and further registered through the high precision parameter extracting method. Consequently, according to the present invention, the optimum parameters are automatically extracted at high precision and in a short period of time using a computer.

In the present invention, the GA sets a plurality of parameter set populations, creates the parent selection table for each population, performs the operation of crossing or recombination or mutation to the parent, checks the constraint condition of the parameters, deletes the non-adapting individual and generates new parameters, performs the genetic operation for L times, moves the specific parameter sets between the parameter set populations in the meantime, and repeats the operations for m generations to calculate the fitness, so that the optimum parameters are extracted at high precision in a short period of time using a computer.

The parameter extracting device in the simulation of the present invention is a device for, with respect to a general simulation such as used in designing or experiment, selecting parameters when performing the simulation and extracting the optimum value of the parameter.

As a specific example of the present invention, the parameter extracting device for forming the OPC, PPC, or EPC pattern will now be described. However, the present invention is not limited to such specific example, and may be used for various other specific examples such as semiconductor device simulation, semiconductor manufacturing process simulation etc.

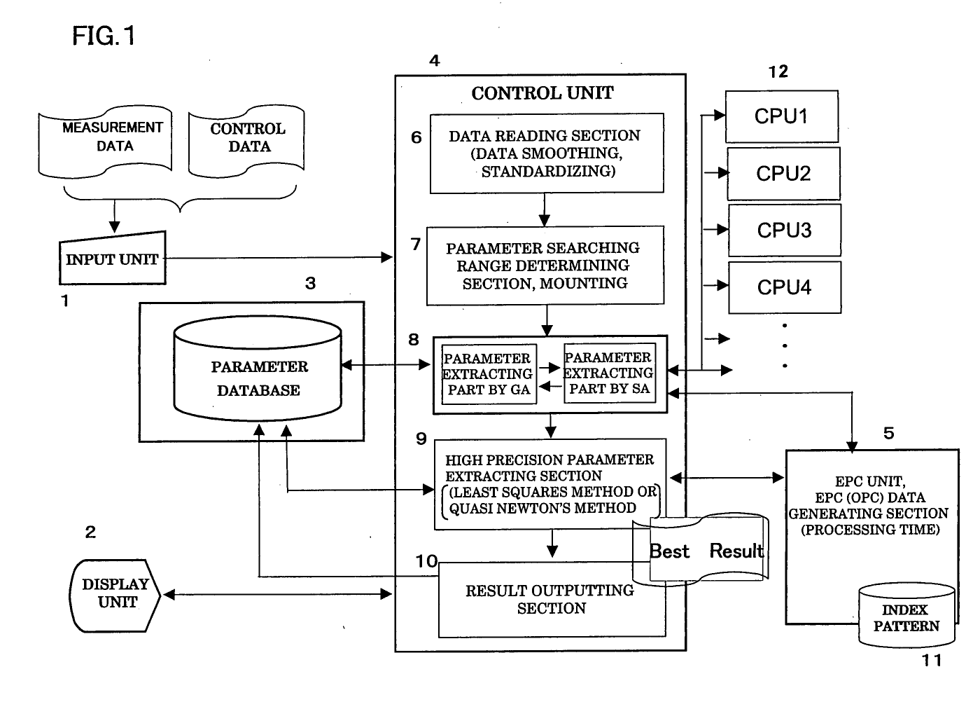

FIG. 1 is a configuration block diagram of a parameter extracting device of the present invention. The parameter extracting device of the present invention is configured by an input unit 1, a display unit 2, a parameter database 3, a control unit 4, and an EPC (or OPC, PPC) unit 5. In particular, the parameter extracting device of the present invention is characterized in including a parameter extracting section 8 and a high precision parameter extracting section 9 in the control unit 4, the parameter extracting section 8 including a parameter extracting part 8a by GA or a parameter extracting part 8b by SA. The characterizing sections cooperate with other sections to embody the device of the present invention and realize the method of the present invention.

The input unit 1 is a keyboard, mouse, scanner, or a pointer device, and is a unit for inputting data or providing instruction, command or selection to the parameter extracting device. The input unit 1 may be a communicating unit for inputting data via a communication line such as a network. The actual measurement data and system control data may be input from the input unit 1.

The display unit 2 is a display device such as liquid crystal display device, plasma display device, or CRT and displays the midterm report or result of the device of the present invention and also displays the data or instruction, command, or selection input from the input unit 1. Alternatively, the display unit may be a communication terminal for outputting the result of the device of the present invention or data via the communication line such as network.

The parameter database 3 is a mass storage unit such as hard disc, optical disc, DVD, or flash memory, and stores the data related to the parameter targeted by the present invention and program for realizing the parameter extracting method of the present invention. In addition, the parameter database 3 stores the program for controlling the input unit 1 and the display unit 2. The parameter database 3 may be integrally configured with the device of the present invention but may also be built by being connected with the communication line such as network.

The control unit 4 is the main operating unit of the device of the present invention, and specifically, is configured by high speed operating CPU, and executes various processes such as below by operating the program stored in the semiconductor device such as flash memory or RAM. The program used may be stored in the mass storage unit such as the parameter database 3 or may be stored in the storage section (not shown) arranged in the control unit 4. The control unit 4 includes a data reading section 6, each parameter searching range determining section 7, a parameter extracting section 8 by GA or SA, high precision parameter extracting section 9, and a result outputting section 10. Each section is a section that is virtually represented when the control unit 4 is operated.

The data reading section 6 reads the measurement data and performs smoothing or normalization of the data. That is., determination is made whether or not the data deviated from the distribution function is significant data, useless data or data that degrades precision through statistical determination of the read data, and smoothing or normalization is performed to enhance the precision of the parameter. In some cases, smoothing and normalization are both performed.

The parameter searching range determining section 7 determines the searching range for each parameter. The searching range is first the searching range from the upper limit to the lower limit if the physical upper limit and the lower limit of the parameter are already defined. If the physical upper limit and the lower limit of the parameter are not defined, the searching range is first the searching range from negative infinity to positive infinity. Infinity is a large value that can be processed by the computer and is input as an exponential value. The searching range is binarized for computer processing. The searching range is first searched in a wide range and then sequentially narrowed as registration is performed through the genetic algorithm or simulated annealing method, or high precision extracting method in the process of registration of each parameter.

The parameter extracting section 8 includes the parameter extracting part 8a by GA and the parameter extracting part 8b by SA, where the GA parameter extracting part 8a or the SA parameter part 8b extract the necessary parameters or parameter sets from a great number of parameters and optimizes each parameter. The evaluation function is used to this end.

In the parameter extracting section 8, the distributed processing by a plurality of CPUs 12, CPU1, CPU2, CPU3, CPU4, is more effective depending on the load of the CPU. When distributed processing is performed, the operation itself of the GA or the SA can be performed for each small population of each parameter set, whereby the change is accelerated and can be allocated for each CPU when a plurality of evaluation functions are present. The distributed processing of the CPU has been described, but the effects of the present invention further become significant when distributed to PCs (Personal Computer), each PC being connected through network to allow exchange of the parameter set.

The distributed processing will be hereinafter described in FIGS. 2 and 3.

The high precision parameter extracting section 9 narrows the parameters at high precision and automatically extracts the optimum solution to obtain the optimum solution in which the error from the actual measured value becomes a minimum through the linear solving method or the non-linear solving method. Specifically, the least squares method or the quasi Newton's method is used.

The result outputting section 10 outputs the parameters and the optimum solutions obtained by the GA parameter extracting part 8a or the SA parameter extracting part 8b, and the high precision parameter extracting section 9, respectively.

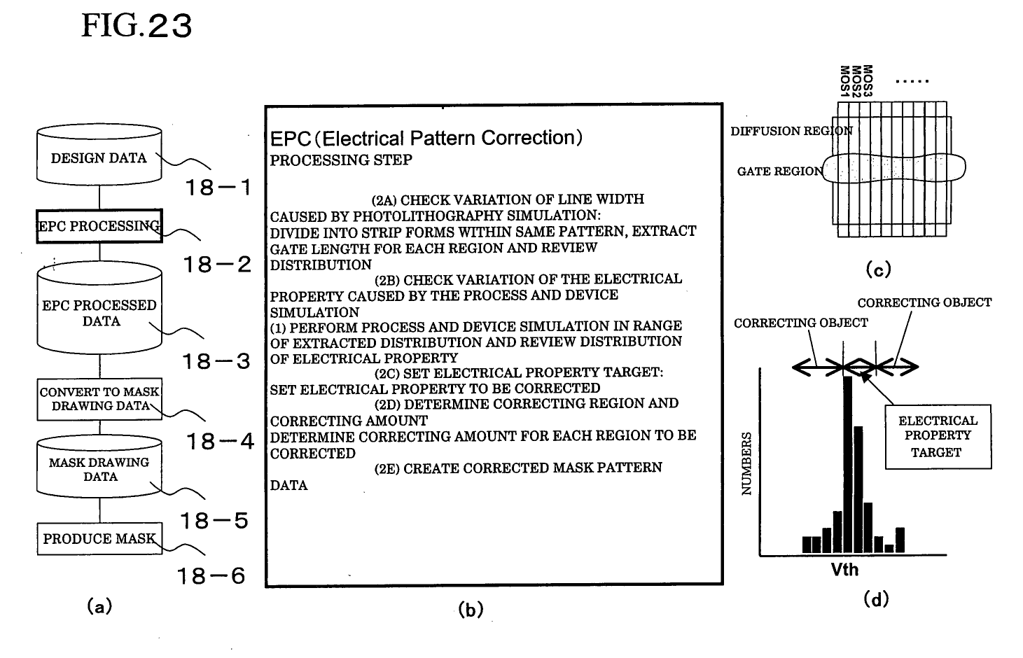

The EPC unit 5 is configured by a data processing section such as a flash memory, and forms the EPC or OPC data generating section using the parameters and the optimum solutions obtained by the GA parameter extracting part 8a or the SA parameter extracting part 8b, and the high precision parameter extracting section 9, respectively. That is, as explained in FIG. 23, the optimum parameter is extracted based on the actual measured value obtained with the TEG (Test Element Group) evaluation and the like in advance for the correction of the mask pattern in which the fabricating dimension of the gate, contact hole and the like of the transistor becomes a desired value from the electrical property of the transistor to be obtained in the semiconductor integrated circuit or the system liquid crystal display device. The high precision mask pattern in which the electrical property and the variation of the electrical property of the satisfactory transistor become a minimum is then extracted through fitting. An index value is calculated using an index pattern database 11 including dense pattern and characteristic pattern of the LSI, and the EPC or the OPC processing time is calculated.

As described above, the parameter extracting device of the present invention becomes more efficient when utilizing the distributed processing system employing a plurality of CPUs or PCs to reduce the processing time. Furthermore, it is more effective to build a neural network in the database of the extracted parameter, and using the same in time of extracting the parameter by GA or SA method or in time of extracting parameter with the conventional method. In particular, the time can be further reduced as the cumulative number of extraction increases in the neural network due to the learning effect.

FIG. 2 is a view explaining the calculating procedures of the distributed GA. According to the present invention, the extraction data is measured, the measured data is input to the parameter extracting device of the present invention, and genetic algorithm and high precision parameter extraction are performed using the computer to automatically extract an optimum parameter, as shown in FIG. 2. The time from when the optimum parameter is automatically extracted until checked by the technician becomes about a few minutes to a few hours by using the parameter extracting device of the present invention.

The automatic extraction of the parameter by the genetic algorithm generates populations A1 to Aj as a plurality of parameter sets, and generates m populations. The m populations are respectively assumed as the initial populations, and GA operation is then performed. The details of the GA operation will be hereinafter described in detail. The populations are individually moved in the next step. The parameter set is selected, and the selected parameter set is moved between the parameter sets. Such operation is operated for n times. FIG. 2 shows that the i^{th} operation has been performed.

The convergence and the calculation time can be greatly reduced by performing the GA operation on a plurality of parameter set populations, and moving the set between populations as necessary.

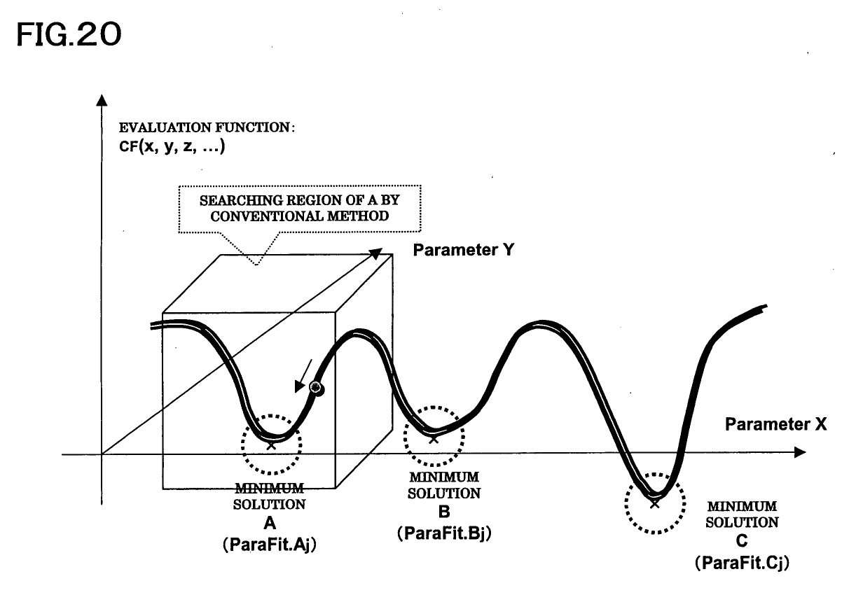

As necessary means, for example, intentionally moving the best individual or worst individual(parameter set) and the like from the current population group to another population group when a certain parameter set is a minimum solution, that is, a local minimum (local minimum will be hereinafter described in FIG. 20) and not an optimum solution. The situation may drastically change at this state to greatly shorten the convergence and the calculating time. Therefore, as necessary refers to the operation that is intentionally performed. Random, on the other hand, means performing the operations not intentionally but completely at random according to, for example, a random number table, through the methods defined in advance.

When performing such GA operation, distributed processing may be performed by allocating each Aj population to the respective CPU or MPU. The number of distribution may be equal or the distributing number and amount may be determined according to the processing capacity and the processing amount of each CPU or MPU. Desirably, each CPU or MPU is connected to allow the parameter sets to be exchanged and moved.

FIG. 3 is a view explaining the calculating procedures of the distributed parameter automatic extraction combining the SA method and the GA method. The schematic configuration is the same as the distributed GA shown in FIG. 2. In FIG. 3, the GA operation of FIG. 2 is changed to the SA or GA operation, and population A is changed to population B. In the case of the distributed parameter extracting device combining the SA method and the GA method as well, the convergence and the calculation time are greatly reduced by performing the SA operation or the GA operation in a plurality of parameter set populations, and moving the sample between the populations as necessary.

When performing such SA operation or GA operation, distributed processing may be performed by allocating each Bj population to the respective CPU or MPU. The number of distribution may be equal or the distributing number and amount may be determined according to the processing capacity and the processing amount of each CPU or MPU. Desirably, each CPU or MPU is connected to allow the parameter sets to be exchanged and moved.

The GA used in extracting the parameter at high precision and in a short period of time in the parameter extracting section 8 of the present invention will now be generally described.

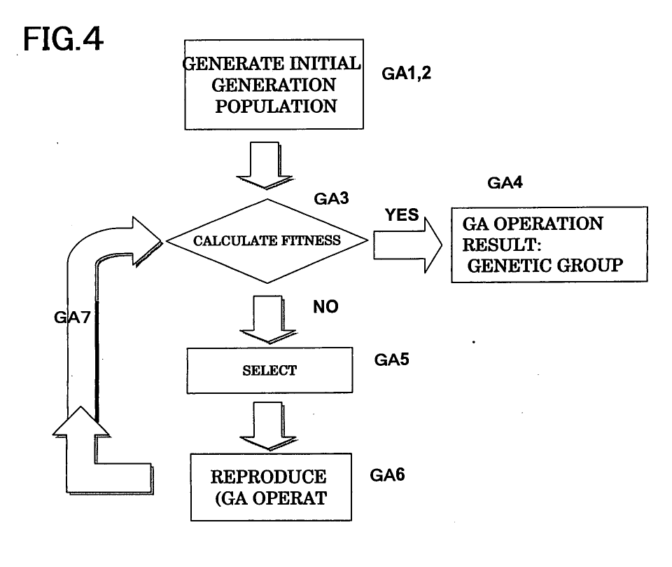

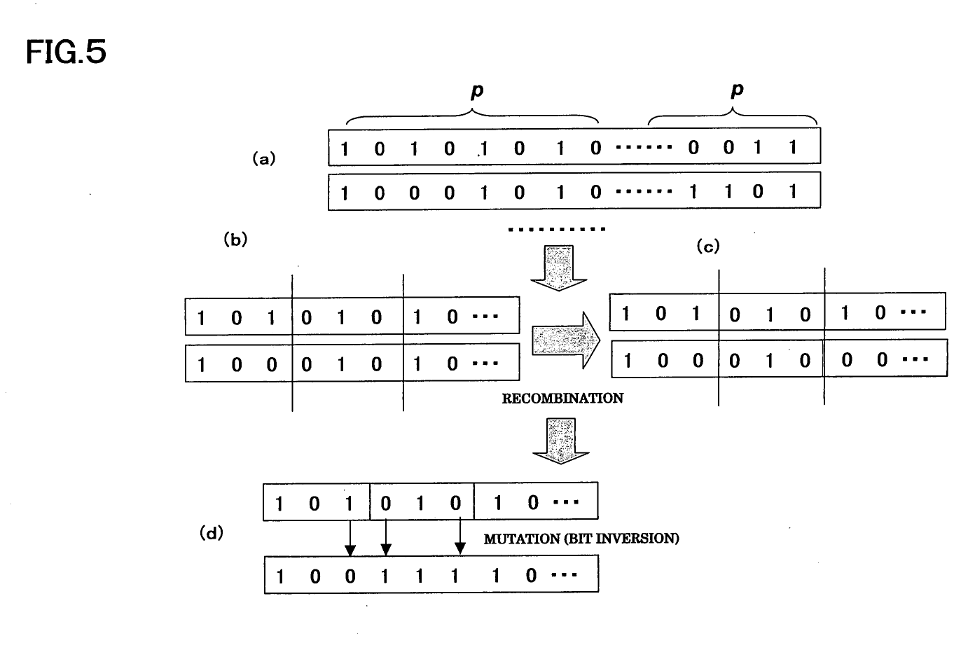

GA is a solution searching and optimizing method derived from the mechanism of the evolution of the living body. This is a method of searching and determining the quasi optimum values of a great number of parameters in a short period of time. For example, a plurality of “genes” representing the solution candidates in the binary bit sequence is prepared, and the evaluation function representing the goodness of the genes is referred to as “applicability”. The gene is evaluated with the applicability, where those not applicable are deleted, and recombination, mutation, or hybridization of the genes is repeated to search for the optimum solution. FIG. 4 shows the calculating procedures of the GA, and FIG. 5 shows the conceptual diagram of the operation.

As shown in FIG. 4, the first step GA1 is a step of generating the initial generation population. To this end, the solution of the targeting problem is coded. Step GA2 is a step for randomly generating the initial generation. In step GA3, the fitness is calculated for each individual of the current population generated in steps GA1 and GA2, determination is made on the terminating conditions such as number of generations, and if the result is YES, the genetic group is formed in step GA4 as the GA operation result. The determination of the terminating conditions includes determining whether the result in the evaluation function exceeds a certain reference, or a specification, and becomes satisfactory, in addition to the number of generations. If the result is NO, the individual having high fitness is selected from the current population in GA5, and the process proceeds to step GA6. In step GA6, the GA operation is performed on the individual selected in step GAS to perform reproduction, and the next generation population is generated. The next generation population generated in this manner returns to step GA3, and the individual determined with the terminating condition is extracted as the genetic group.

FIG. 5 shows a conceptual diagram for explaining the operation of the GA, where FIG. 5(a) shows the sequence of the parameter data of a first parent and the sequence of the parameter data of a second parent. FIG. 5(b) shows a partial sequence of the data extracted from the parent data of the first parent and the parameter data of the second parent. Each bit sequence is inverted with a predetermined probability from the first parent and the second parent, crossing or hybridization are performed, and two individual “child” of the next generation shown in FIG. 5(c) are generated. Mutation occurs by randomly changing the bits in crossing or hybridization to generate the “child” as shown in FIG. 5(d). In FIG. 5(d), three bits are inverted from the data sequence of the parent shown on the upper level of FIG. 5(b), indicating mutation. This is merely for explanation, and not many mutations occur as shown in FIG. 5(d). The number of bits and the position of the bit that cause mutation are randomly set.

Since the registration of a few tens of the lithography parameters becomes necessary in the registration of the OPC or the PPC model parameter, automatic registration task of the parameters can be performed at high precision and in a short period of time by using the GA method.

The simulated annealing method is an algorithm simulating the annealing method of thermal process, and is a algorithm targeting the optimum solution by sometimes selecting the intermediate solution in which the searching distance becomes long to move out from local minimum (locally minimum value) with respect to the conventional local searching distance measurement method of searching for the optimum solution in which the searching distance becomes short.

When the searching distance is long compared to the original distance, the probability of adopting such step lowers if the increase in the distance is large. If the increase in the distance is small, the probability of adopting such step increases. The probability of selecting long distance lowers with elapse of time to aim for an eventually stable state.

When solving the shortest distance searching problem and the like with the simulated annealing method, the probability of moving out from the local minimum becomes higher, as opposed to the conventional local searching method. Therefore, the optimum solution can be obtained. The GA may not allow moving out from the local minimum depending on the frequency or the timing of gene recombination, and the optimum solution may not be obtained in considerable times as in the conventional method. In this case, a more distinguished solution is sometimes obtained with the simulated annealing method.

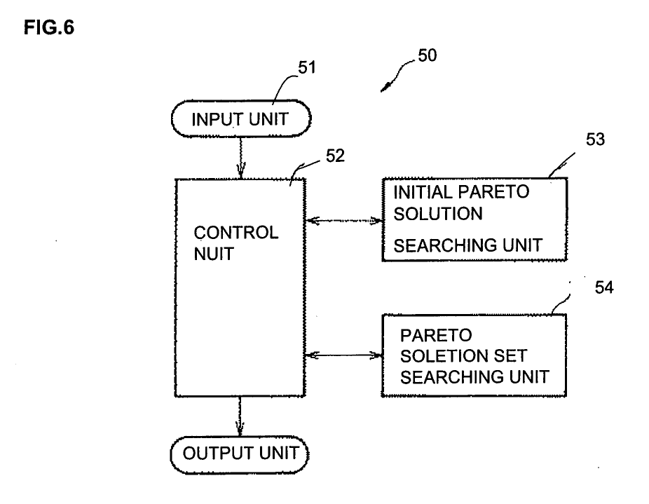

FIG. 6 shows the basic configuration of an optimum processing device according to the present invention. The optimum processing device 50 comprising a input unit 51, a control unit 52, an initial pareto solution searching 53, a pareto solution set searching unit 54, an out put unit 55.

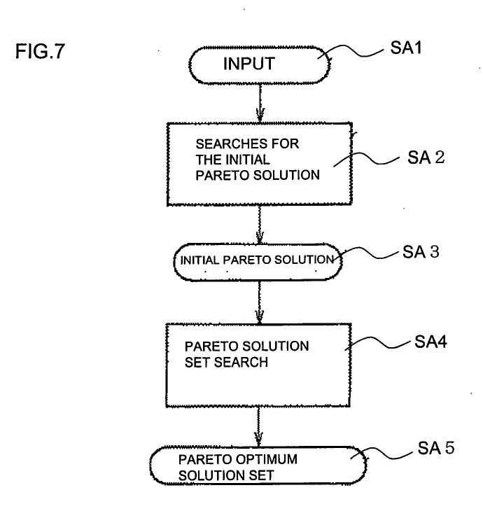

FIG. 7 shows the basic processing flow of the optimum processing device according to the present invention. In the optimum processing device 10 according to the present invention, when a problem is input (SA1), the initial pareto solution searching unit 53 searches for the initial pareto solution (SA2). The pareto solution set searching unit 54 searches for the pareto optimum solution set using the initial pareto solution (SA3) obtained by the initial pareto solution searching unit 53 (SA4). The output unit 55 outputs the pareto optimum solution set as the result (SA5).

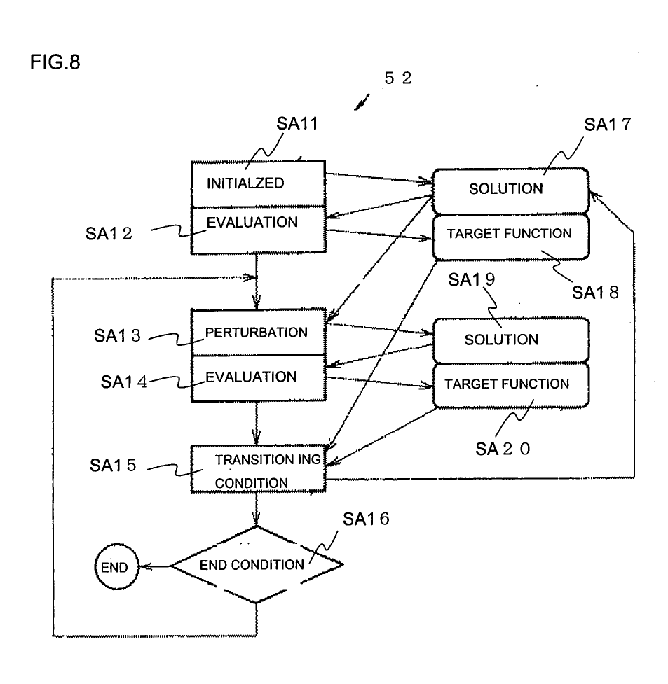

FIG. 8 shows one example of the control flow of the initial pareto solution searching unit 53. The initial pareto solution searching unit 53 of the present example is configured based on the method of the simulated annealing method (SA). The simulated annealing method is a method applied to the problem in which the gradient information or continuity cannot be assumed in the searching space, a problem in which the searching space is large and a great number of constraint conditions exist and thus is difficult with the conventional method of linear planning method and the like. A different method that provides a solution similar to the solution obtained by the simulated annealing method may also be used.

In briefly explaining the simulated annealing method with the n purpose minimizing problem of m integer variables as an example, the variable X is X(x1, x2, . . . , xm), and the target function F is F=(F1, F2, . . . , Fn), F1=F1(X), F2=F2(X), . . . , Fn=Fn(X). In using the SA, the evaluation function of SA must be the scalar function. To this end, a plurality of target functions of a multi-purpose problem must be made to scalar through some kind of method.

For example, assuming the probability p of transitioning from a certain individual r to another individual s is p=exp(−Q/T) (metropolis method).

T is temperature,

Q=w1*ÄF1+w2*ÄF2+ . . . +wn*ÄFn,

ÄFj=Fj(s)−AFj(r), if Fj(s)>ÄFj(r), otherwise 0, j=1, 2, . . . , n, and

w1, w2, . . . , wn are positive constants.

The pareto optimum solution of the original multi-purpose problem may not be achieved due to approximation by scalar. However, the SA is used as a means for obtaining the initial pareto solution of the GA for solving the original multi-purpose problem, and the final pareto solution set is searched by the GA, whereby the influence of approximation is eliminated and does not become a problem.

In FIG. 8, the Q value to be minimized by perturbation by the state variable X is evaluated. In this evaluation, determination is made whether or not the Q′ value after perturbation is in the decreasing direction from the Q value before perturbation, and the target function F is recalculated according to the result (SA11 to SA14 and SA17 to SA20). Next, determination is made whether or not to transition to the state after perturbation using the above described transitioning probability p, and transitions to the state after perturbation when the transitioning condition is satisfied (SA15 and SA17). This process is terminated when a predetermined number of repetitions, calculation time or improvement in solution is not recognized over a certain number of times (SA16).

A specific embodiment of the present invention will now be described in detail.

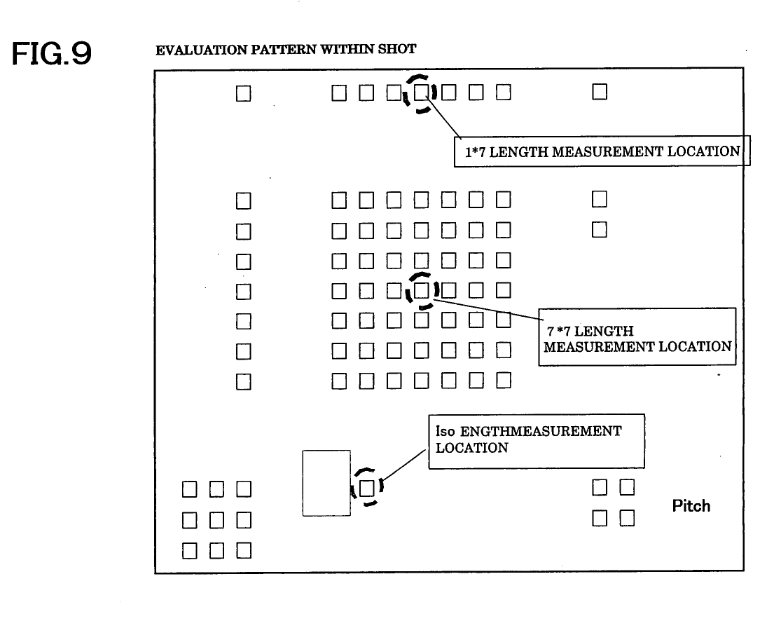

A specific example of the lithography parameter extracting procedures in a 130 nm LSI process (contact layer) is shown as a specific example. FIG. 9 shows the TEG pattern of the actually measured contact layer. FIG. 9 shows a dense pattern that becomes the base, and a characteristic pattern of the LSI widely used in memory cells and the like. The seven square patterns shown at the upper portion are locations for measuring the length of the sequence of one column, and the square pattern at the middle is assumed as the length measuring location of 1*7. The square patterns of seven by seven shown at the central portion are the locations for measuring the length of the high density sequence, and the square pattern at the middle is assumed as the length measuring location of 7*7. The one square pattern shown at the lower portion is the location for measuring the length of the isolated pattern. In addition, an arbitrary length measuring pattern may be created.

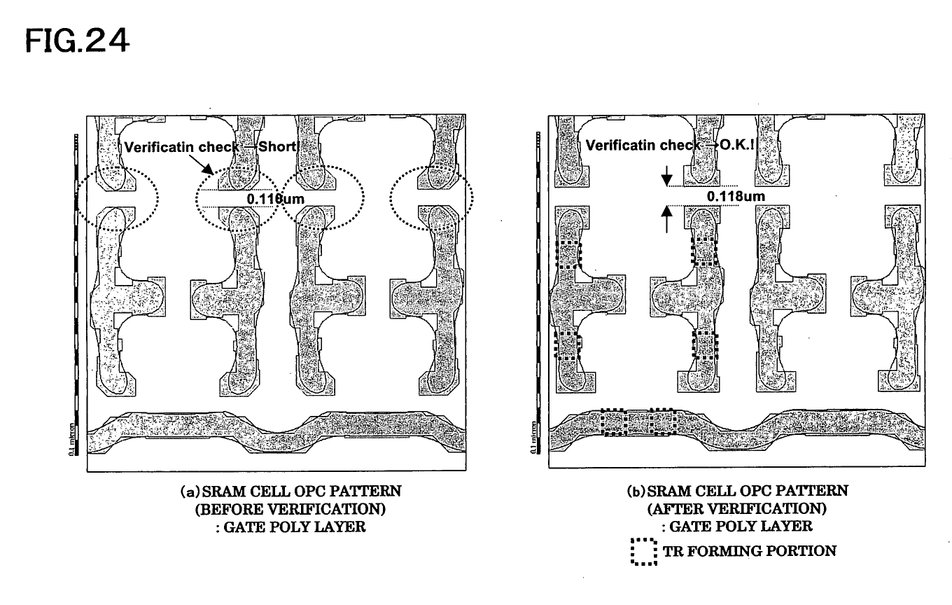

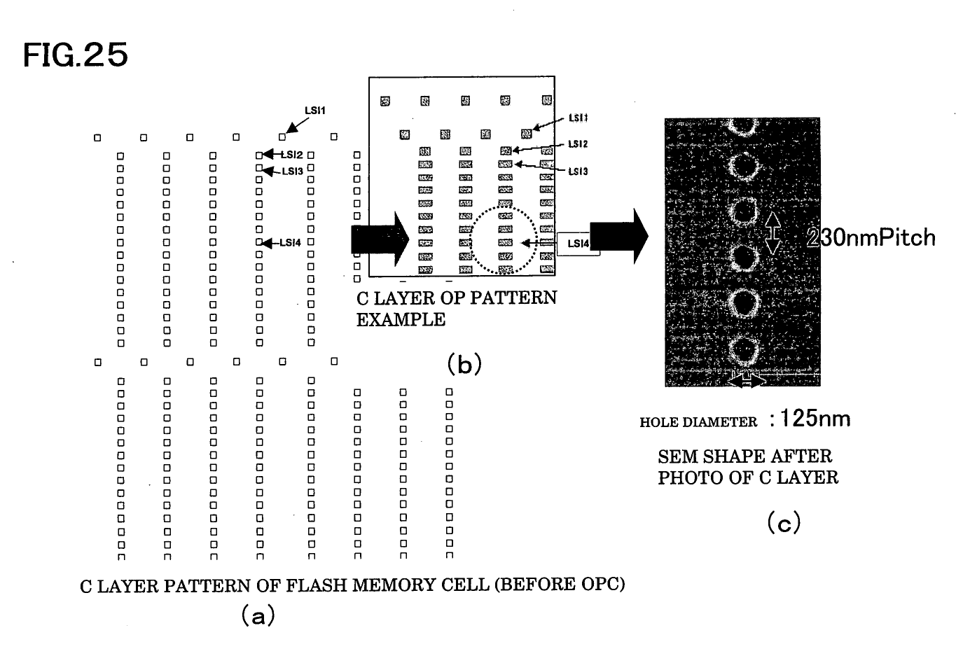

The patterns are shown as imitations of the OPC pattern of the gate-poly-Si layer or the transistor forming part of the SRAM shown in FIG. 24, and the pattern of the C layer of the flash memory shown in FIG. 25.

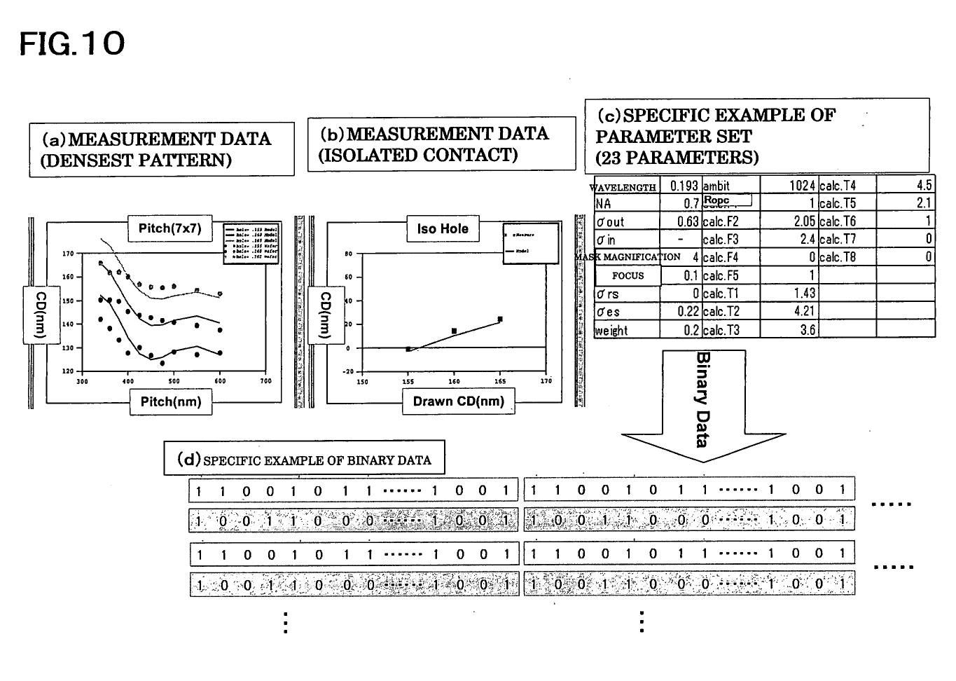

FIG. 10(a) shows the measurement result of measuring the densest pattern of 7*7, where the horizontal axis of the figure indicates the pitch (unit in nm), and the vertical axis indicates the CD(Critical Dimension) value (unit in nm). In the figure, the dot shows the measured value, and the curve shows the calculated value. FIG. 10(b) shows the measurement result of the isolated contact of the ISO hole, where the horizontal axis of the figure indicates the Drawn CD (unit in nm), and the vertical axis indicates the CD value (unit in nm). In the figure, the dot shows the measured value, and the curve shows the calculated value. FIG. 10(c) shows a specific example of a PPC (include lithography) parameter set (group) to be extracted. FIG. 10(d) is a view for explaining an example in which the PPC (include lithography) parameter set (group) shown in FIG. 10(c) is replaced with the binary expression of 1, 0 based on the searching range and the precision to be obtained of the solution. The binary data of FIG. 10(d) is a view for only explaining the binary expression and does not indicate the binary data of a specific parameter. To become the operating object of the GA to be hereinafter described, the binarization is known to adopt Gray-coding*, Real-GA** etc. for the GA with the actual number as the target.

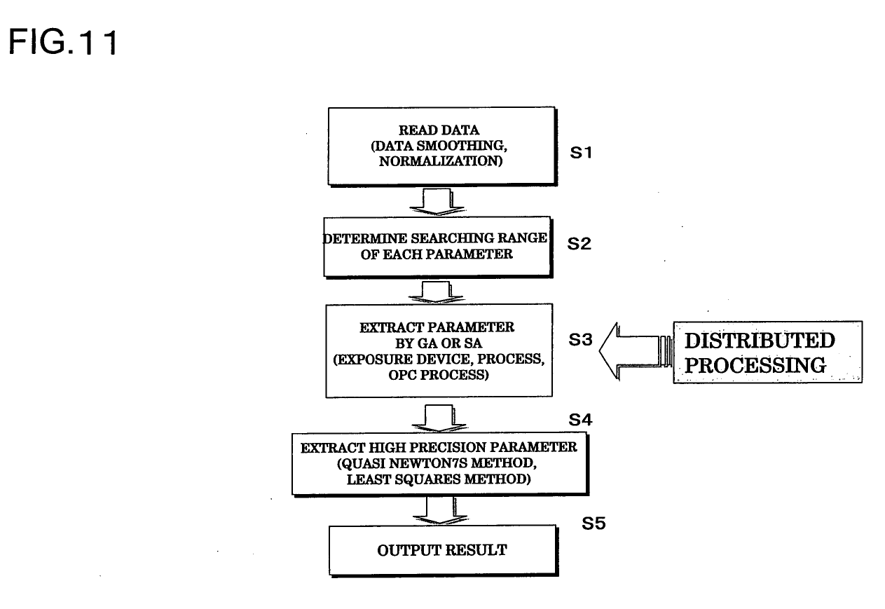

With regards to the PPC (include lithography) parameter binarized as described above, the operation of the GA is repeated according to the procedures shown in FIGS. 11 to 13 to extract the parameter, and the solution to be obtained is searched by the high precision parameter extraction. The flow charts of FIGS. 11 to 13 are performed by reading the program of the present invention from the parameter database 3 and sequentially executing the process. The following flow chart is similarly performed.

As shown in FIG. 11, when the actual measurement data and the control data of the system are first input by the input unit 1, the data is read by the data reading section 6, and smoothing or normalizing, or both smoothing and normalizing are performed (S1). The searching range of each parameter is then determined by the parameter searching range determining section 7 (S2). The searching range is normalized and binarized.

Thereafter, GA or SA is repeated by the parameter (group) extracting section 8 to extract each parameter or parameter group (S3). In this case, the parameters are divided into a plurality of parameter set assemblies and the GA operation or the SA operation is individually performed, instead of performing a single assembly GA operation or SA operation, as shown in FIG. 2 and FIG. 3. It is important to overlap the operation and the generation at times while moving the parameter set. Consequently, the result of satisfactory convergence is obtained in a shorter period of time.

The precision calculated from the difference in the actual measured value and the calculated value, and the OPC processing time for calculating the index value using the dense pattern or the characteristic pattern of the LSI are used for the evaluation function of the GA operation or the SA operation. Preferably, the compatible value is calculated by the AND condition of precision and time. Furthermore, the parameters are extracted at high precision from the parameters extracted in step S3 through the linear solving method or the non-linear solving method, more specifically, through the least square method or the quasi Newton's method and the like in the high precision parameter extracting section 9. The optimum solution of each parameter obtained as above is output to the result outputting section 10 and the result is displayed on the display unit 2.

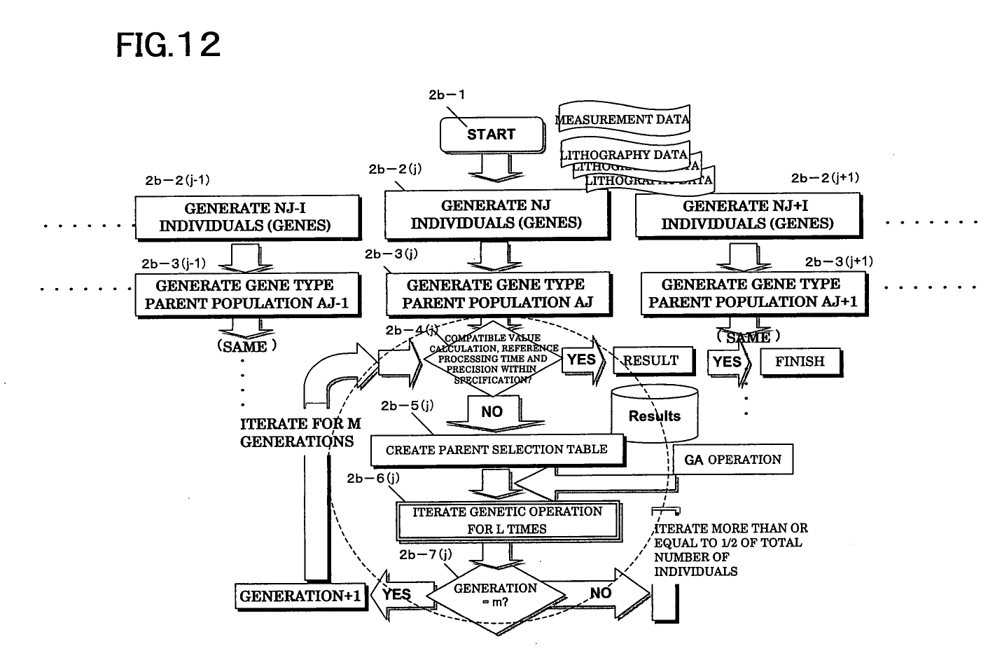

The details of parameter extraction by the GA shown in step S3 will now be explained using FIG. 12 illustrating the flow chart of lithography parameter extraction. The following description is made on Nj individuals, parent population Aj, shown in the middle column of FIG. 12 but similar process is performed on Nj−1 individual, parent population Aj−1 shown on the left side column of FIG. 12, and the Nj+1 individual, parent population Aj+1 shown on the right side column.

2b-1: In this step, the lithography parameter and the measurement data read in step S1 of FIG. 11 and determined with the searching range in step S2 are input. The specific example of the lithography parameter and the measurement data are shown in FIG. 10(c). As shown, for example, 23 parameters of wavelength, NA, ó out, óin, mask multiplication, focus órs, óes, weight, Ropc, calc.F1 . . . calc.F5, calc.T1 . . . calc.T8 are provided. The types and numbers of the parameters are merely an example and are not limited thereto, and thus may be more or may be less. The check for the constraint condition is also performed at this point. The constraint condition of the exposure device indicates quasi fixed values such as wavelength ë)(=0.193, NA=0.70±0.05, ó=0.63±0.05. These are quasi fixed values but become parameters within the range of the set precision.

2b-2(j): In this step, Nj individuals (parameters) are produced using random number, distribution function or the like from the lithography parameters obtained in step 2b-1.

M (a plurality of) parameter set assemblies must be set. The operation of GA is hereinafter individually performed in each assembly. j=1 to M

2b-3(j): M (a plurality of) groups (parent population) Aj of the parameter set are generated from Nj individuals (parameters) obtained in step 2b-(j). parameter set assembly Aj=1 to M

2b-(j): In this step, the compatible value calculation for the parameter obtained by step 2b-3(j) is performed. In the compatible value calculation, the precision(1) in each parameter set is calculated with (equation 3) through the evaluation function. The processing time(2) is calculated with (equation 5).

2b-5(j): The selection table of “parent” is created to perform recombination or crossing in the GA from the parameter sets obtained in step 2b-3(j) and 2b-4(j). The combination of the parameter sets to be recombined or crossed is determined in the table.

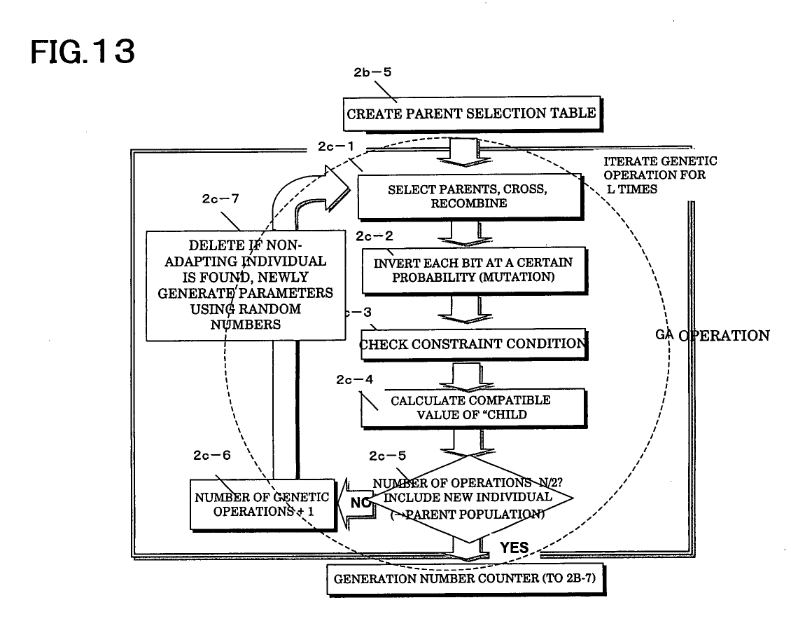

2b-6(j): In this step, GA operations are iteratively performed over L times for the selection table of “parent”. If the non-adapting individual is found, such individual is deleted and the parameter is newly produced using random number. The detail of the genetic operations for L times is hereinafter described in FIG. 13.

2b-7(j): In order to repeat the GA operation for m generations, the number of generations is counted, and when the number of generations is not m, the process returns to 2b-6(j) to iterate for more than or equal to ½ the total number of individuals. If the number of generation is m, 1 is added to the number of generations to iterate for m generations, and the process returns to flow 2b-4(j).

The precision(1) in the compatible value calculation of the step 2b-4(j) is performed using the evaluation function in which the sum of the squares of the difference between the measured value and the value of the selected group is weighed as shown in (eq. 3). The GA operation of higher efficiency is thereby realized.

Example of evaluation function

$$F ( r ) = Const . - r = Const . - ( 1 / N ) * [ {\sum }_{i}^{N} weight ( i ) * \{ Mes ( i ) - Sam ( i ) \} 2 ] 1 / 2 \qquad ( eq . 3 )$$

where

$$r = ( 1 / N ) * [ {\sum }_{i}^{N} weight ( i ) * \{ Mes ( i ) - Sam ( i ) \} 2 ] 1 / 2$$

(N is the number of measurements, i is the data number, Mes(i) is the i^{th} measured value, Sam(i) is the i^{th} sampled value, and weight(i) is the i^{th} weighed value).

In (eq. 3), the measured value is used as it is, but if the standard deviation ó(i) is known, a more efficient GA operation can be realized by normalizing with {Mes(i)−Sam(i)}ó(i) and using the result.

Furthermore, the natural selection by the GA operation can be further accelerated by selecting the group in proportion to the compatible value. For example, in the selection table of the parent, an efficient GA operation can be realized with fewer number of individuals and fewer number of generations by defining the probability of selection by (eq. 4).
The selection probability∝(F(r)−Min.F)/(Max.F−Min.F) (eq. 4)
(The compatible value F(r) is assumed to be smaller the better and to be a positive actual number).

With regards to the processing time(2) in the compatible value calculation of step (2b-4(j), specifically, for the Hole system layer, the index pattern collecting the basic pattern as shown in FIG. 9 is actually PPC processed (may be estimated) as the sample parameter to generate the PPC pattern, and the processing time is calculated under the calculator condition actually using the same. The evaluation of the samples less than or equal to the practicable allowable value á, (â) is then performed. That is,

Example of evaluation function G(t)
G(t)=TCPU(A)*TCPU(B) . . . TCPU(A)<á and TCPU(B)<â (eq. 5)

Other than the above

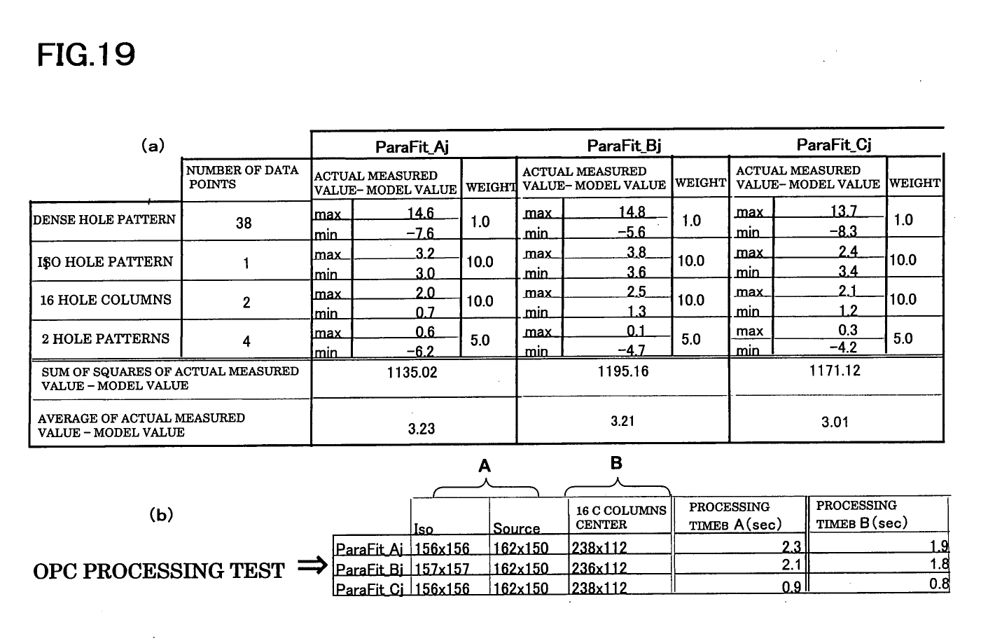

FIG. 19(b) shows the processing time A of the Iso and source, and the processing time B of sixteen C column patterns as the index pattern.

From the two evaluation functions shown in (eq. 3) and (eq. 5), the comprehensive evaluation is performed in the form of T(r,t)=F(r)*G(t) and the like. The evaluation result is preferably the minimum value, where the result is the better the smaller.

The content of the genetic operation iteration of L times of step (2b-6(j)) of FIG. 12 will now be described with the flow chart of FIG. 13.

2c-1: According to the parent selection table created in step 2b-5(j), the parameter set of the both parents is selected and crossed or recombined.

2c-2: When crossed or recombined in step 2c-1, a certain parameter set is selected and a certain parameter is bit inverted. The parameter and bit selected at this point are selected using random numbers. The mutation thereby occurs.

2c-3: The parameter set of the result of performing the operations of step 2c-1 or 2c-2 is checked under constraint condition.

2c-4: The “child” generated through crossing or recombination is calculated for the compatible value using the evaluation function. The evaluation function is AND of the precision(1) and the processing time(2) of the reference pattern.

2c-5: Determination is made on whether or not the number of operations is less than N/2 or greater than or equal to N/2, and if the number of operation is less than N/2, 1 is added to the number of genetic operations (2c-6), and the process returns to the first step (2c-1) of the flow to repeat the above operation. When returning to the first step (2c-1), if non-adapting individual is found, such individual is deleted, and the parameters are newly generated using random numbers (2c-7). When the number of operation is greater than or equal to N/2, the process proceeds to the generation number counter (2b-7(j) of FIG. 12).

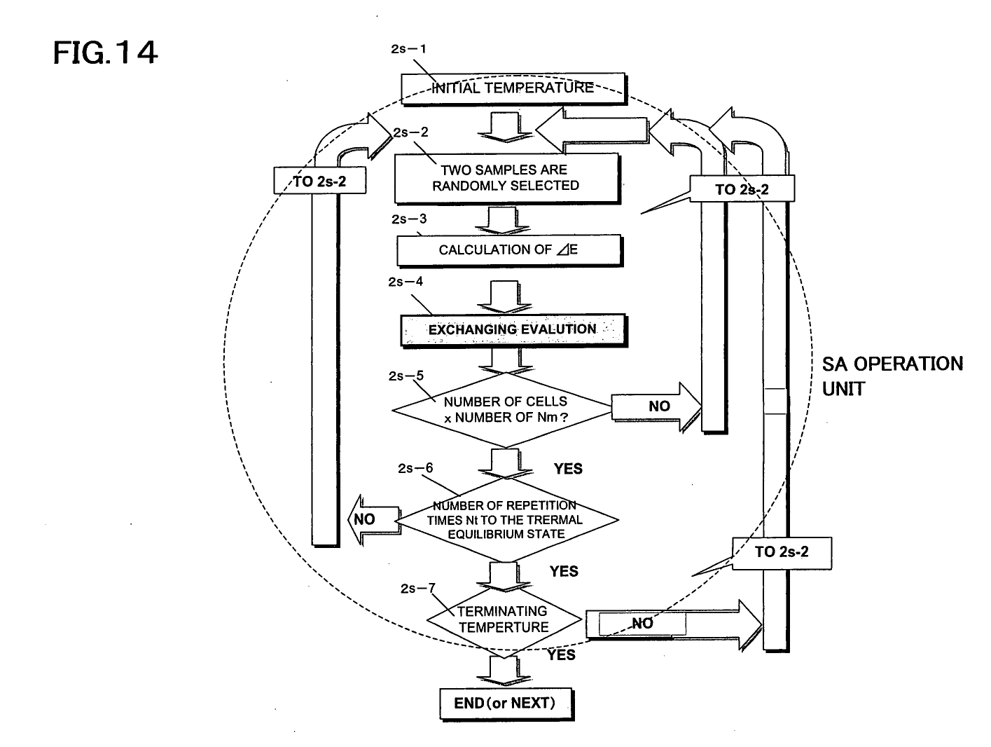

The details of parameter extraction by the SA shown in step S3 will now be described using FIG. 14.

The simulated annealing method is an algorithm imitating the annealing of metal and the like. When the metal and the like is annealed, the substances heated at high temperature are gradually cooled, and at an absolute temperature of 0 degree, the molecules are rearranged to a state the internal energy becomes a minimum and a crystal structure of a larger dimension is formed. The annealing method is viewed as a physical process in which the crystal structure where the substance structure has less defects and lower energy is obtained. The SA method is for obtaining an optimum configuration for the optimization problem consisting of a great number of elements by imitating the process with a computer.

The simulated annealing method sequentially performs the following processes. First, the individual is randomly selected from the selection table created by the parameters set by the parameter setting section. The cost or the energy function of the selected individual is calculated. That is, the parameter exchanging operation is performed, with the error between the actual measured value and the simulation value or the calculating time of the evaluation pattern as the energy, so as to minimize the error and the calculating time. The next generation individual is generated in this manner, a check is made on whether the number of simulations, temperature, and thermal equilibrium state are satisfactory with respect to the generated individual, and the compatible value satisfying the above conditions is calculated.

FIG. 14 illustrates the flow chart of the SA operation unit. The initial temperature is first set in step 2s-1. Next, two samples are randomly selected in step 2s-2. E is calculated in step 2s-3. In the calculation of E, the energy difference between the two samples is calculated. Various methods are used in the calculation of the energy function E. Such methods include a method of obtaining the sum of the squares of the difference between the actual measured value and the model value in time of parameter setting, that is, the minimum energy, or the process in a typical pattern in time of parameter setting.

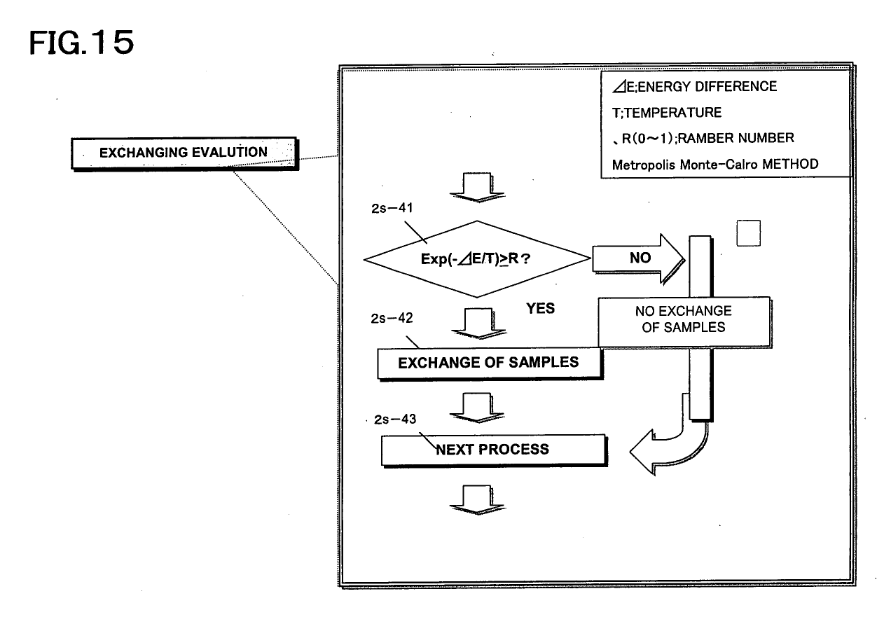

The exchanging evaluation is exchanged in step 2s-4. The exchanging evaluation is described using FIG. 15. With regards to the result, the number of cells×number of Nm is determined in step 2s-5. If the determination results in NO, the process returns to step 2s-2.

If the determination in step 2s-5 results YES, the process proceeds to step 2s-6, and the number of repetition times Nt to the thermal equilibrium state is determined. If the number of times Nt is not satisfied, the determination results in NO, and thus the process returns to step 2s-2. If YES, the terminating temperature is determined in step 2s-7. If not the terminating temperature, the process returns to step 2s-2. If the determination result of the terminating temperature is YES, the flow is terminated, or proceeds to a next step.

FIG. 15 illustrates the detailed flow chart of step 2s-4.

In step 2s-41, Exp(−E/T)>R is determined. E is the energy difference, T is the temperature, and R(0−1) is the random number. In this example, the Metropolis Monte-Cairo method is used.

If YES in step 2s-41, the process proceeds to the next step 2s-42, and the samples are exchanged. The process proceeds to the next process in step 2s-43, and the flow is terminated.

If NO in step 2s-41, the samples are not exchanged, and the process skips to step 2s-43.

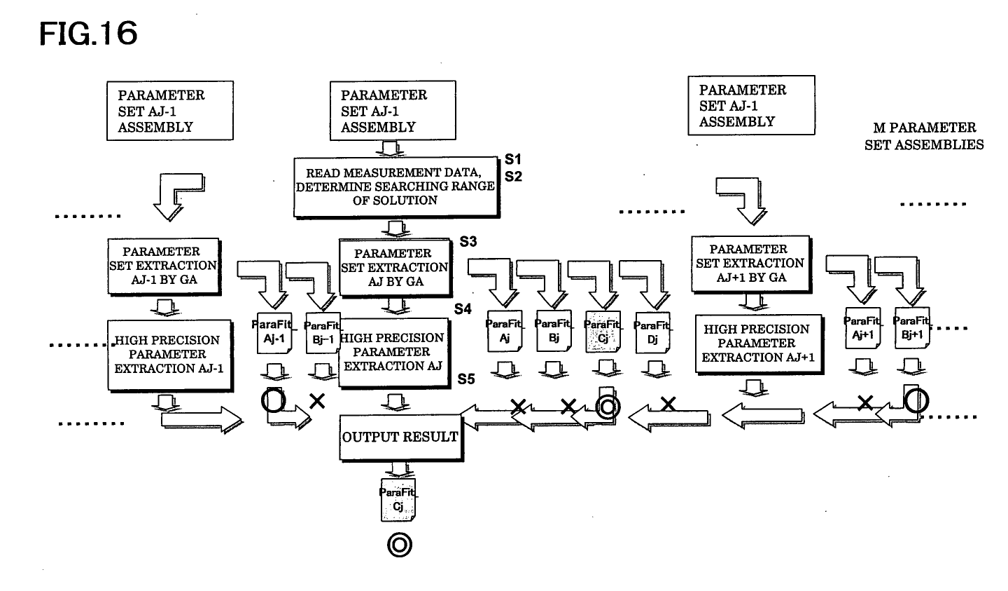

Out of the plurality of (satisfying compatible value calculation) solutions obtained by repeating the operations, the minimum solutions A. B, C are shown in FIG. 16 to FIG. 19. FIG. 16 shows the extraction flow similar to FIG. 11, and shows the state of dividing into a plurality of parameter set assemblies, individually performing the operation of the GA or SA, and sometimes overlapping the operation and the generation while moving the parameter sets. The parameter set Aj assembly is shown in the middle column of FIG. 16, the parameter set Aj−1 assembly is shown on the left side column, and the parameter set Aj+1 assembly is shown on the right side column. M number of parameter sets is present.

As shown in FIG. 16, the measurement data is first read and the searching range of the solution is determined. The extraction of the parameters by GA is then performed. Thereafter, in order to obtain the optimum solution that minimizes the difference from the actual measured value, the optimum parameter is extracted with high precision parameter extracting method, and the result is output. In the flow shown in FIG. 16, the double circle shows that paraFit.Cj is the optimum solution. The single circle shows that paraFit.Aj−1, Bj+1 are worse than paraFit.Cj. X mark shows. that paraFit.Aj, paraFit.Bj, paraFit.Dj, paraFit.Bj−1, paraFit.Aj+1 . . . are not optimum solutions.

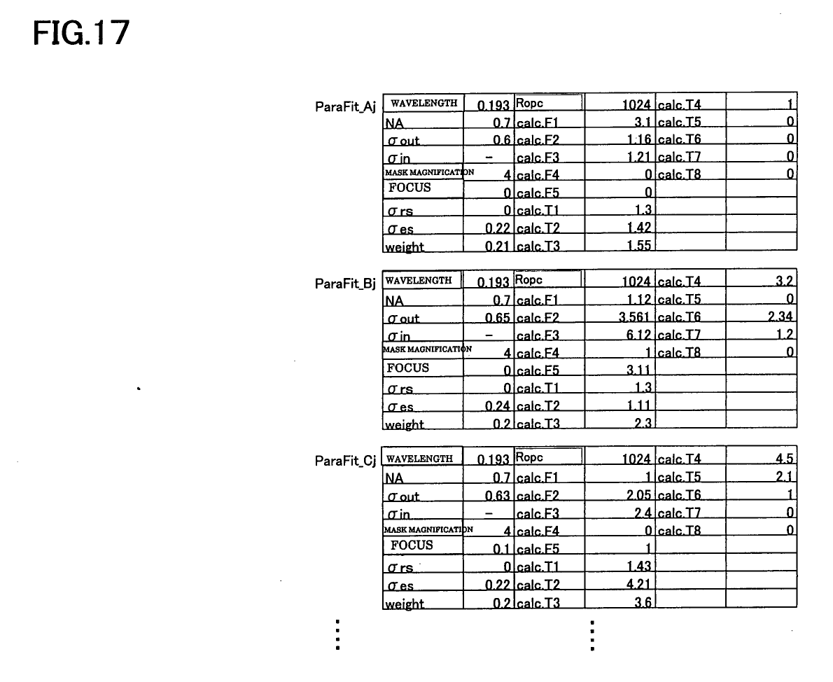

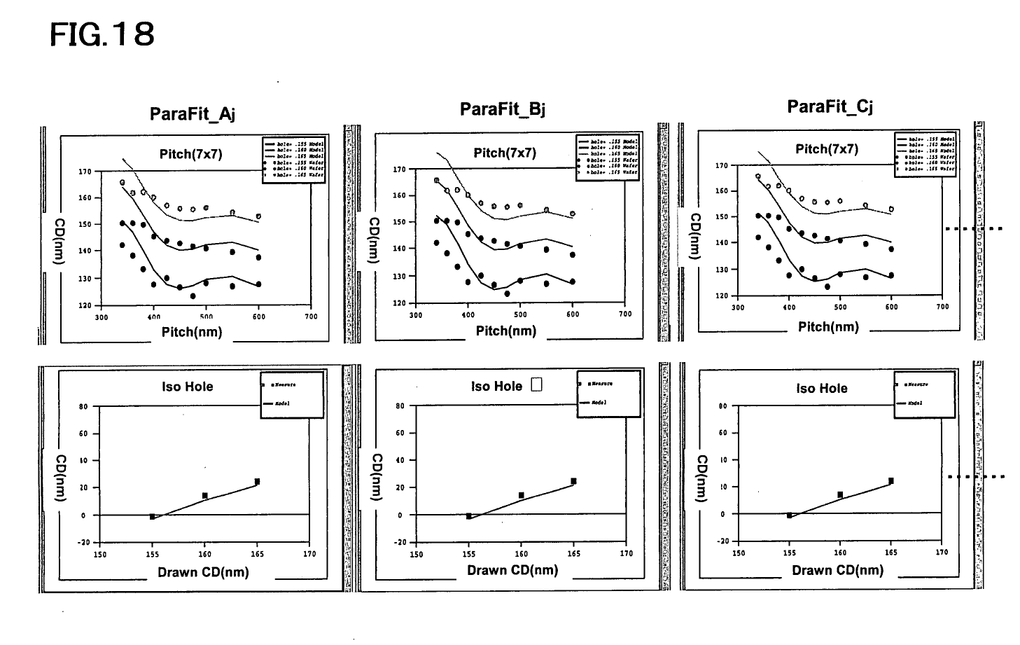

FIG. 17 shows the numerical values for each paraFit.Aj, paraFit.Bj, paraFit.Cj as the actual PPC parameter set. FIG. 18 shows the state of registration to the actual measured value of each solution for pitch of 7×7 and IsoHole with respect to paraFit.Aj, paraFit.Bj, and paraFit.Cj.

The horizontal axis of the graph showing the pitch of 7×7 of FIG. 18 indicates the pitch (unit in nm), and the vertical axis indicates the CD value (unit in nm). In the figure, the dot shows the measured value, and the curve shows the calculated value. The horizontal axis of the graph showing the isolated contact of IsoHole of FIG.18 indicates the Drawn CD (unit in nm) and the vertical axis indicates the CD value (unit in nm). In the figure, the dot shows the measured value, and the curve shows the calculated value. As apparent from FIG. 18, the measured value and the calculated value satisfactorily match.

The precision and the OPC processing time of each minimum solution in the present invention are shown in FIG. 19 as the evaluation result. FIG. 19(a) shows the relationship between the actual measured value—model value of parameter fitting paraFit.Aj to paraFit.Cj and the weight for the dense hole pattern (number of data points is 38), the ISO hole pattern (number of data point is 1), 16 hole columns (number of data point is 2), and two hole patterns (number of data point is 4). The sum of squares of the actual measured value—model value and the average of the actual measured value—model value are shown on the lower column of the table. FIG. 19(b) shows the PPC processing time in paraFit.Aj, paraFit.Bj, paraFit.Cj for Iso, source and 16 C column centers as the result of the OPC processing test.

As shown in FIG. 16 to FIG. 19, in particular, as shown in FIG. 19(a), paraFit.Cj is found to be the optimum solution from the sum of squares of the actual measured value and the model value and the average of the actual measured value and the model value. As shown in FIG. 19(b), the paraFit.Cj is found to be the optimum solution from the processing time.

FIG. 20 shows that the paraFit.Aj, paraFit.Bj, paraFit.Cj are minimum solutions A, B, C in the above embodiments, and that the paraFit.Cj becomes the optimum solution. However, if the method of obtaining the solution from the gradient and the like of the evaluation function as in the conventional method, the optimum solution C may be missed due to the fitting of the minimum solutions A and B etc.

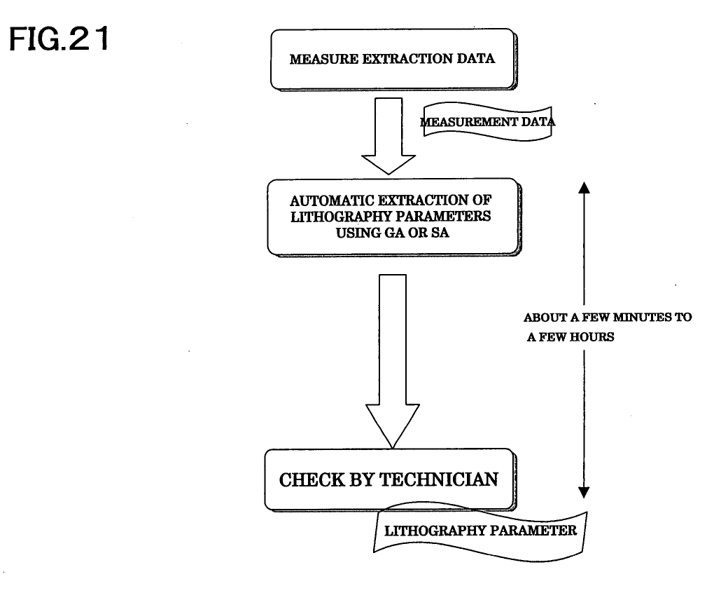

The result of the optimum parameter extraction time in the embodiment of the present invention is shown in FIG. 21. As shown in FIG. 21, the extracting data is measured, the measured data is input to the parameter extracting device of the present invention, the parameter is extracted through GA or SA method using the computer, the optimum parameter solution is obtained, the high precision parameter extraction is performed, and the result is checked by the technician thereby obtaining the optimum parameters in about a few minutes to a few hours.

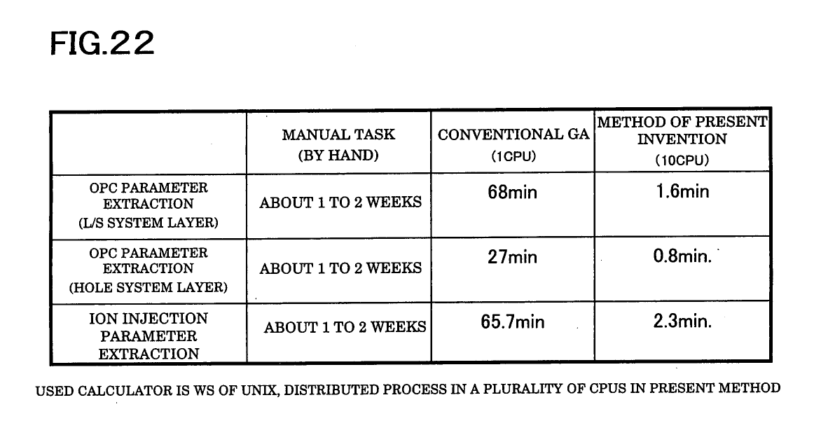

FIG. 22 shows the conventional method by manual task, and the parameter extraction time by the method of the present invention for the OPC parameter extraction of the L/S system layer, the OPC parameter extraction of the Hole system layer, and the ion injection parameter extraction. The task that required two weeks or more in the conventional method is greatly reduced and is about a few minutes according to the present invention.

Since the optimum parameter of the simulation or the optimum parameter of the lithography simulation are obtained as above in the present invention, the pattern of the exposure mask subjected to optical proximity effect correction or process proximity effect correction is obtained based on the final solution. The EPC unit 5 is configured by the data processing section such as flash memory, and forms the EPC or the OPC data generating section using the parameter and the optimum solution obtained with the GA parameter extracting part 8a or the SA parameter extracting part 8b, and the high precision parameter extracting section 9.

The optimum parameter is extracted based on the actual measured value obtained with the TEG evaluation and the like in advance for the correction of the mask pattern in which the fabricating dimension of the gate, contact hole and the like of the transistor becomes a desired value from the electrical property of the transistor to be obtained in the semiconductor integrated circuit or the system liquid crystal display device. The high precision mask pattern in which the electrical property and the variation of the electrical property of the satisfactory transistor become a minimum, which is electrical pattern correction (EPC), is then extracted through fitting. The exposure mask is produced from the relevant pattern, the pattern is formed on the semiconductor surface using the exposure mask, and the semiconductor is manufactured through the etching step.

It should be apparent to those skilled in the art that the present invention may be embodied in many other specific forms without departing from the spirit or scope of the invention. Therefore, the present invention is not to be limited to the details given herein, but may be modified within the scope and equivalence of the appended claims.

1. A parameter extracting device in a simulation comprising:
a parameter setting section for setting a plurality of parameters necessary in a simulation;
a first parameter extracting section for extracting parameters adapted to the simulation through a genetic algorithm or a simulated annealing method from the plurality of set parameters; and
a second parameter extracting section for registering the extracted parameters through a high precision parameter extracting method, and fitting the parameters at high precision.

2. The parameter extracting device in the simulation according to claim 1, wherein the parameter setting section includes a population generating part for generating a plurality of parameter set populations from the plurality of parameters, a selecting part for selecting the parameter set population to be moved between the parameter set populations, and a movement part for moving the selected parameter set population between the parameter set populations.

3. The parameter extracting device in the simulation according to claim 2, wherein the plurality of parameter set populations are distributed processed with a plurality of CPUs or a plurality of MPUs.

4. The parameter extracting device in the simulation according to claim 1, wherein the parameter setting section includes an input part for inputting actual measurement data and system control data to be simulated, a data reading part for smoothing and normalizing the input actual measurement data, and a parameter range determining part for determining the range of the precision and the parameter value of the object to be simulated based on the read data.

5. The parameter extracting device in the simulation according to claim 1, wherein the genetic algorithm selects a parent from a parent selection table created by the set parameters, generates the individual of the next generation through the operations of crossing or recombination, or mutation of the parent, checks the constraint conditions of selecting the parameters adapted to the simulation with respect to the generated individual, performs the genetic operations for L times of deleting the individual not adapted to the constraint conditions and generating new parameters, and further repeats the genetic operations of L times for m generations to calculate a compatible value of the parameters.

6. The parameter extracting device in the simulation according to claim 1, wherein the simulated annealing method randomly selects an individual from the selection table created by the set parameters and calculates a cost or a energy function, performs a parameter exchanging operation so as to minimize the cost or the energy function to generate the next generation individual, checks whether the number of simulations, temperature, and thermal equilibrium state are satisfactory with respect to the generated individual, and calculates a compatible value satisfying the conditions.

7. The parameter extracting device in the simulation according to claim 1, wherein the first parameter extracting section evaluates the extracted parameters through a precision calculated from the difference in the actual measured value and the calculated value or the processing time calculated using the characteristic pattern of the simulating object, or an evaluation function including the precision and the processing time, and extracts the parameters adapted to the simulation.

8. The parameter extracting device in the simulation according to claim 6, wherein the precision uses the function of weighing the sum of the squares of the difference of the measured value and the calculated value of the selected group.

9. The parameter extracting device in the simulation according to claim 1, wherein the second parameter extracting section obtains an optimum solution of the parameters in which the error with the actual measured value is minimized.

10. The parameter extracting device in the simulation according to claim 1, wherein the second parameter extracting section includes a least square method or a quasi Newton's method.

11. The parameter extracting device in the simulation according to claim 1, wherein the parameter setting section sets the parameters necessary for simulation of photolithography of a photomask for semiconductor manufacturing, semiconductor device, and the semiconductor manufacturing process.

12. A parameter extracting method comprising the steps of:
a parameter setting step for setting a plurality of parameters necessary in a simulation;
a first parameter extracting step for extracting parameters adapted to the simulation through a genetic algorithm or a simulated annealing method from the plurality of set parameters; and
a second parameter extracting step for registering the extracted parameters through a high precision parameter extracting method, and fitting the parameters at high precision.

13. The parameter extracting method in the simulation according to claim 12, wherein the genetic algorithm selects gene type proportionate at least one gene type to fitness.

14. The parameter extracting method in the simulation according to claim 12, wherein the first parameter extracting step selects the optimum value of the extracted parameter based on the function having the calculating time of performing the processes of optical proximity effect correction (OPC) or process proximity effect correction (PPC) or an electrical pattern correction (EPC) of the mask pattern as a minimum.

15. The parameter extracting method in the simulation according to claim 12, wherein the first parameter extracting step selects the optimum value of the extracted parameter based on the calculating time with an minimum isolated line or space pattern or densest line and space pattern based on the design rule or the unit pattern characteristic to the LSI.

16. The parameter extracting method in the simulation according to claim 12, wherein the first parameter extracting step selects the optimum value of the extracted parameter based on a value satisfying the performance required for the predicted value of the electrical property of the transistor by the process or device simulation, or a value in which the threshold value variation caused by line width variation becomes a minimum.

17. The parameter extracting method in the simulation according to claim 12, wherein the second parameter extracting step compares the optimum value of the extracted parameter with the measurement data in which the resist shape on a photo printed wafer is measured and data in which the electrical property of the pattern shape on the TEG evaluated wafer or the experimentally manufactured transistor is measured, and selects the parameter adapted to the measurement data.

18. The parameter extracting method in the simulation according to claim 12, wherein the parameter values of the optical proximity effect correction (OPC), process proximity effect correction (PPC), or electrical pattern correction (EPC) are extracted from the parameters obtained by the second parameter extracting step.

19. A photomask using corrected mask data created from the parameters extracted through the parameter extracting method according to claim 12.

20. A semiconductor device formed using the photomask according to claim 19.

21. An optimum parameter extracting system comprising:
an input unit for inputting actual measurement data and system control data;
a control unit including a data reading section for smoothing and normalizing the input data, a parameter searching range determining section for determining a searching range of each parameter to be extracted, a plurality of first parameter extracting sections using a genetic algorithm, a selection unit for selecting a sample (i.e., specific parameter set) to be moved from a population of each parameter set, a movement unit for moving the sample between the populations of each parameter set, a second parameter extracting section using a high precision parameter extracting method, and a result outputting section for outputting a final solution extracted by the first parameter extracting sections and the second parameter extracting section; and
a parameter database.

22. A parameter extracting program executed by a computer, the program comprising the steps of:
a parameter setting step for setting a plurality necessary in a simulation;
a first parameter extracting step for extracting parameters adapted to the simulation through a genetic algorithm or a simulated annealing method from the plurality, of set parameters; and
a second parameter extracting step for registering the extracted parameters through a high precision parameter extracting method, and fitting the parameters at high precision.

23. A computer readable medium recorded with the program according to claim 22.
